(19) United States
(12) Patent Application Publication
(10) Pub. No.: US 2025/0130784 A1
(43) Pub. Date: Apr. 24, 2025

(54) CODE COMPILATION FOR DYNAMIC PEER-TO-PEER NETWORKED CODE EXECUTION AND DATA MANAGEMENT

(71) Applicant: Sanket Diwale, Boston, MA (US)

(72) Inventor: Sanket Diwale, Boston, MA (US)

(21) Appl. No.: 18/833,050

(22) PCT Filed: Jan. 29, 2023
(86) PCT No.: PCT/US23/11796

§ 371 Date: Jul. 25, 2024

Related U.S. Application Data
(60) Provisional application No. 63/267,298, filed on Jan. 29, 2022.

(51) Int. Cl. G06F 8/41; G06F 8/30

(52) U.S. Cl. CPC G06F 8/45; G06F 8/314

(57) ABSTRACT

The present invention concerns a method and apparatus of supporting the compilation of an input computer program to create a collection of computer programs as its output, wherein the output computer programs working with the supporting apparatus are capable of creating self-organizing and dynamically changing peer-to-peer networks of computing devices during execution of the output computer programs, and performing distributed computations and data processing on such formed networks so as to accomplish the tasks described in the input computer program.

### RELATED APPLICATION INFORMATION

This application claims priority to provisional application Ser. No. U.S. 63/267,298 filed on Jan. 29, 2022, the contents of which are incorporated herein by reference.

### BACKGROUND

### 1. Field of Invention

This invention relates to computer systems and, more particularly to methods and apparatus to generate and execute code in a dynamic networked environment, optionally forming peer-to-peer connections.

### 2. Discussion of Related Art

Parallel (synonymously called distributed) execution of computer code is a common approach to accelerating computer programs. Parallel execution also becomes essential for tackling large-scale computation tasks requiring data and computational resources that exceed a single computer's capacity. The parallelization of a computer program thus requires the distribution of data and computation across several computing machines connected via a communication network or via sharing of computer memory.

The execution of a computer program or code in parallel requires several steps of prior preparation, such as:
1. partitioning the computer program into a collection of computer programs executable in parallel without affecting the original program's outcome,
2. distributing the collection of computer programs to a collection of computing nodes that can execute the programs or their copies in parallel on different input data,
3. identifying and distributing the data to be fed to the different computing nodes,
4. inserting instructions in the separated programs to send and receive data and wait for the required data, using a communication or shared memory network
5. inserting instructions to combine results from different computing nodes to obtain results required by the original computer program.

Examples of commonly used parallel computing nodes are vector computing units in CPUs, multicore processors, Graphics Processing Units (GPUs), or multi-computer systems such as supercomputers.

The steps required to prepare a program for parallel execution are generally performed by a human programmer, at least in part. The programmer may manually write a necessary collection of supporting computer programs such as those required to identify and distribute data, partition the original program, and insert instructions such as those required for communication or combining parallelized results. Examples of such preparation are available when programming with programming frameworks like OpenMP for multithreading, OpenCL for GPU computations, or MPI (message passing interface) over computer networks. The program code and data distribution to the various computing nodes use a communication or memory sharing network.

Another approach to preparing a program for parallel execution is to write a program entirely assuming sequential (i.e., non-parallel) execution and then transform the program using a compiler containing an automatic parallelization algorithm. Examples of such automatic parallelization algorithms are found in patent numbers U.S. Pat. No. 8,621,448B2 disclosing systems and methods for compiler-based vectorization of non-leaf code, U.S. Pat. No. 8,296,743B2 disclosing a compiler for heterogeneous multicore computing, U.S. Pat. No. 8,037,465B2 disclosing an automatic multithreading compiler.

Contemporary art in automatic parallelization comes with certain limitations, one of which requires a static assignment of resources at or before runtime. Another limitation assumes the availability of a memory sharing mechanism or static communication links between the computing nodes, typically within a local area network. The limitations make the code generated unsuited for execution on peer-to-peer networks where peers (computational nodes) can dynamically join in or drop out of a communication network during program execution. The dynamic nature of the communication links and resource allocation requires additional steps for the reliable execution of code and for resource allocation and organization of connections in dynamic networks, optionally including peer-to-peer connections.

Furthermore, peer nodes across the internet are distributed in distinct local area networks, separated by network address translation (NAT) units preventing the nodes from directly finding or communicating with one another, thereby limiting the scale of distribution to a local network. Presently, a manual process of programming is used to prepare programs for distributed computing across an internet-scale peer-to-peer network.

An example of the current art in network computing on nodes spread across the internet is presented by the Berkeley Open Infrastructure for Network Computing (BOINC). With BOINC, peers are client computers (called clients) that connect to a centralized server application (called server). A human programmer is required to write both the client and server programs to perform the parallelized execution. Clients request computing jobs and data from the server. The server is programmed to respond to a job request by sending the application code and data from a database connected to the server. The requesting clients then execute the application code and upload the results to the server. The operations restrict computations to a client-server model. A client can send requests to a server and receive responses in return. However, the server cannot initiate communication on its own to a client. Similarly, two clients in the network cannot communicate with each other directly. Such communication restrictions prevent the efficient execution of distributed algorithms, for example, consensus algorithms, that require the communication of computed values between two or more clients. The current art thus limits the type of network topologies achievable and the scope of parallelization achieved by networked computation.

The invention presented here eliminates such restrictions for networked computing by providing a compiler with automatic parallelization and automatic generation of additional supporting coordination and processing code units for reliable operation in a dynamically changing, self-organizing peer-to-peer network. Another object is to enable peer-to-peer connections across distinct local area networks to be formed and modified dynamically during the execution of a program in response to the computational or functional needs of the program.

### SUMMARY OF THE INVENTION

The invention comprises of two main aspects. The first aspect presents a compiler with automatic parallelization and code generation to support parallel execution, communication and data management for a dynamically changing and self-organizing peer-to-peer network of computational resources. The second aspect concerns the apparatus as a computer implemented method to support peer discovery, network formation, code distribution and execution of the generated code in the formed network.

The first object of the work is to automatically compile or transform a sequential program to a collection of programs executed in parallel on a dynamic network of computational resources, optionally including peer-to-peer connections; whereby the functionality of the original sequential program is accelerated or scaled using the network and the manual programming effort is reduced.

A second object is to enable peer-to-peer connections across distinct local area networks to be automatically formed and modified dynamically during the execution of a collection of programs in response to the computational or functional needs of the programs. The responsive self-organization of the network thereby allows for greater flexibility in resource availability, allocation, and organization of connections between peers spread across a collection of local area networks as found on the global internet. The two objects enable a programmer's sequential code to be transformed automatically into a collection of parallel executing programs that self-organize and execute on a network with dynamic network topology and resource consumption in response to the computational or functional needs of the program.

A third object of the invention is to enable a set of independently compiled programs with the described compiler to run on a peer-to-peer network and interact with each other. The third object is to use the apparatus of the invention to allow one compiled program to connect to peers running a second compiled program and request the performance of functionality that may not be available with requesting program, and receive in return a result of the performed action. The apparatus thus allows nodes in a peer-to-peer network to collaborate by specializing in certain compiled functionalities, providing the compiled functionalities as a service to other nodes and requesting in a similar manner, functionalities from other nodes. The third object naturally also benefits from the advantages gained from the first two objects described previously, thereby allowing the generation of such collaborative programs with automatic parallelization provided by the compiler and the scaling and acceleration of the programs in a responsive and dynamic network formed using the apparatus specified for this purpose.

In one embodiment, the invention provides a computer implemented method of compiling an input computer code, partitioned into a set of code sections, in a manner to support execution of the code sections or computer programs by a plurality of computing nodes of a dynamically changing or extensible network. The method processes the partitioned set of code sections to supplement the code sections with instructions to transmit network reconfiguration requests to the apparatus forming the extensible network for the allocation and addition of a new set of computing nodes to the extensible network. The method further supplements the code sections with instructions to receive network specifications of the new set of computing nodes and with instructions to transmit a subset of the partitioned set of code sections to the new set of computing nodes utilizing the received network specifications. The method thus enables the compiled code sections to cause the distribution of other code sections and cause the allocation of new computing nodes for other code sections in a dynamic extensible network in response to the needs of the partitioned input computer code to facilitate the first object of the invention. In a related embodiment, the method further causes supplementing the code sections with instructions to cause the execution of other code sections on new allocated computing nodes of the extensible network. Other related embodiments, include supplementing the code sections with instructions to exchange data between the code sections by sending requests and responses for the data between the code sections, utilizing the network specifications received for the new set of computing nodes.

In another embodiment, the method for processing the partitioned set of code sections further includes supplementing a second code section, executing on a second computing node, with instructions to receive a transfer request for the transfer of a first code section to a first computing node. The method further supplements the second code section with instructions to respond to the request. The instructions for the response causing transmitting the first code section, if available with the second computing node, and otherwise, sending the request to the apparatus of the extensible network to request the transfer from a third computing node of the network, with access to the first code section. The embodiment supports the first and second object of the invention by enabling the compiled code sections to transfer other code sections from one computing node to another, in a dynamic, extensible network, wherein computing nodes may join and leave the network at will.

In other embodiments of the compiler, the method includes generating, as an additional output, code section specifications for each code section of the partitioned set. The code section specifications may include meta-data for the code section such as the data and control-flow dependencies of the code section on other code sections of the set, estimates for computational, memory, or communication workloads, or external software or hardware dependencies of the code section, or code integrity or credential tokens for the code section. The process for generating the code section specifications may further include identifying a subset of code sections as entry programs, the execution of which is required to initiate execution of the remaining code sections of the set. A labelling of the code sections as entry programs may then be included in the code section specifications.

The apparatus for the invention comprises a resource interface node as a computer implemented method with the authority to allocate computing resources from a connected set of computing resources. The computing resources including computing nodes, network interfaces for creating communication links and other associated computing resources such as computer memory or hardware interfaces or software resources. The resource interface node as a computer implemented includes methods to receive requests from a code section executing on computing node for allocation of new computing nodes, new network connections and for the discovery of computing resources within a second network of resource interface nodes. The resource interface node enables the discovery of optimal resource allocations in the second network through the exchange of offer-response messages to find the best suited allocation for a requested computing resource. The second network of resource interface nodes also enables the exchange of network specifications between the computing nodes to form a first network of computing nodes with new communication links connecting the computing nodes directly to one another. The second network of resource interface nodes enables the discovery of resources outside local network boundaries and enables the second object of the invention for forming a dynamic or extensible network of computing nodes, including peer-to-peer connections between the computing nodes.

In another embodiment, the offer-response mechanisms in the second network of resource interface nodes enables the discovery of network specifications for a set of computing nodes executing a first set of code sections compiled for a first input computer program, for execution requested by a second set of code sections, compiled for a second input computer program thus enabling the third object of the invention.

Further embodiments, objects, and advantages of the invention will become apparent from a consideration of the drawings and ensuing description.

### BRIEF DESCRIPTION OF THE DRAWINGS

The description presents a non-limiting example embodiment of the invention, with reference to the appended drawings, in which:

FIG. 1 is a simplified schematic illustration of an overall apparatus for the invention comprising of a compiler 103 taking in an input computer program 101 and outputting a collection of programs 160 and program specifications 105. The collection of programs and specifications is transferred to a computer connected to an internet-like network 300 consisting of a plurality of computers, exemplified by computers C2-C9 and S1-S2;

FIG. 2 shows a simplified schematic of a peer-to-peer network 350 generated as a result of program execution from collection 160. Computers C3, C5-C7 and S1 from FIG. 1 are shown to have joined network 350. Network apparatus for the invention comprising of a peer-discovery-node 202 is shown running on computer S1 and a resource-interface-node 203 instances are shown running on computers C3, C5-C7. Bidirectional peer-to-peer communication links formed using methods outlined in nodes 202 and 203 are shown as communication links 109-112;

FIG. 3 shows a simplified schematic for internals of compiler 103. A parallelization unit 140 performs tasks of dividing an input program into a collection of programs 145 in an intermediate representation form. A back-end 150 translates programs 145 to a machine executable format to output a collection of executable programs 160;

FIG. 4 is a simplified schematic illustration of internals for compiler front-end 130;

FIG. 5 show a simplified schematic for internals of code-generator 143 used in parallelization unit 140 of compiler 103. Programs 145 are shown further divided into subgroups identifiable by the compiler;

FIG. 6 shows a simplified template code of a data-receiver coroutine 611 generated by algorithm 2 of code-generator 143;

FIG. 7 shows a simplified template code of a data-server coroutine 612 generated by algorithm 2 of code-generator 143;

FIG. 8 shows a simplified template code of a node-transfer coroutine 613 generated by algorithm 2 of code-generator 143;

FIG. 9 shows a simplified template code of a runtime-management coroutine 614 generated by algorithm 2 of code-generator 143;

FIG. 10 is a flow-chart for an embodiment of a procedure or algorithm 1 used by code-generator 143;

FIG. 11 is a flow-chart for an embodiment of a procedure or algorithm 2 used by code-generator 143;

FIG. 12 shows an example of an input computer program 101 shown in a data-flow graph form, partitioned using an analysis-and-partitioning-unit 141 in compiler 103;

FIG. 13 shows the collection of programs 145 output by parallelization unit 140 in data-flow graph form for the example input program shown in FIG. 12. FIG. 13 does not show node-transfer-coroutines and runtime-management-coroutines that may also be additionally generated as part of collection 145;

FIG. 14 is a simplified schematic of resource-interface-node 203 used to support execution of programs 145 or 160 generated by the compiler and used to support formation of a dynamic peer-to-peer network 350 for the distributed execution of programs in collection 160;

FIG. 15 is a simplified schematic of peer-discovery node 202 and its processing methods used to propagate information through network 300 and used to support formation of a peer-to-peer network 350 during execution of programs from collection 160.

FIG. 16 shows a job transfer request being processed by the node 203 labelled “Peer N” to acquire a new node “Peer N2” to transfer the execution of programs running on “Peer N1”. The transfer coroutine acquires the new node “Peer N2” through the advertisement-offer acceptance process outlined in methods 807-809, forming a new peer-to-peer link between “Peer N” and “Peer N2”. The transfer coroutine further transfers the operational data and program codes from “Peer N1” to “Peer N2”.

### DETAILED DESCRIPTION

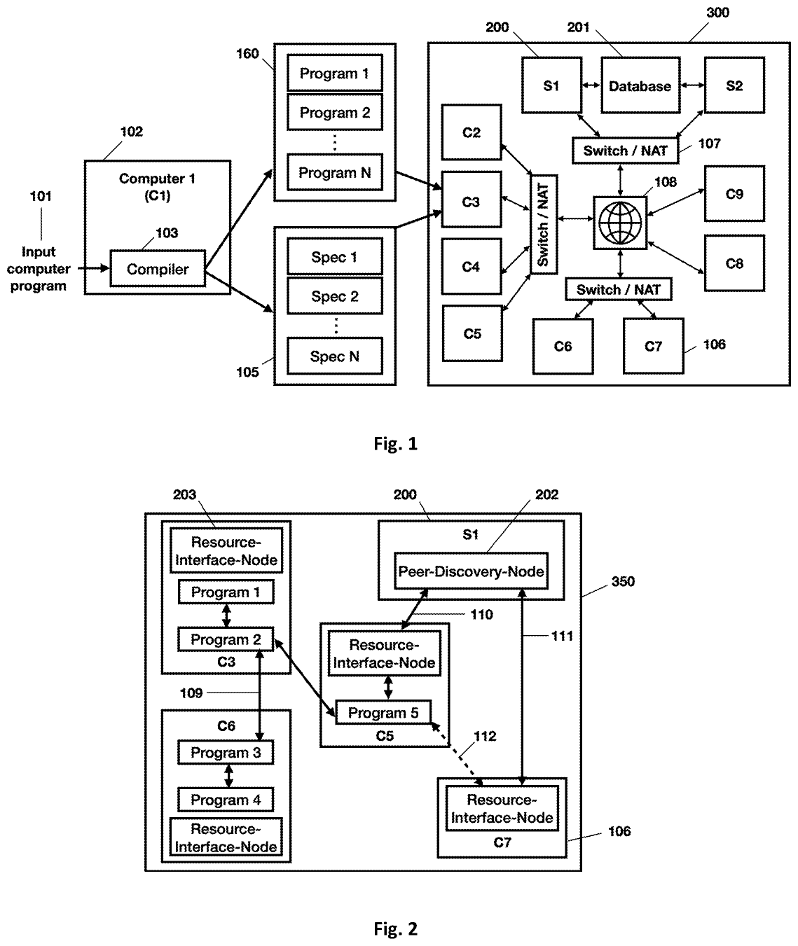

FIGS. 1 and 2 show a simplified schematic of an overall apparatus for the invention. The invention comprises of a specialized compiler 103 with a dynamic, optionally peer-to-peer, network 350 of heterogeneous computing devices as the target architecture for the compiler. FIG. 1 shows compiler 103 as a software application or a set of computer instructions running on a computer 102.

Compiler 103 receives an input computer program 101, analyses and processes program 101, and outputs a collection of computer programs 160 and a collection of program specifications 105. Collections 160 and 105 are transferred to a computer C3 for program execution. The transfer of collections 160 and 105 may be performed by a copy of memory containing the collections from one computer to another using a communication network or other memory storage or transfer devices.

Computer C3 is connected to a network 300 of other computers through a plurality of network interfaces or network switches 107 and 108 as shown in FIG. 1. Switches 107 and 108 may be configured to send messages or information from one computer in the network to another. Network 300 may thus be a local area network or wide area network resembling a local or global internet of computers.

The invention further comprises of an apparatus containing two machines, namely a peer-discovery-node 202 and a resource-interface-node 203. Nodes 202 and 203 are attached to a set of computers in network 300 to support the formation of a dynamic, optionally peer-to-peer, network 350 of computers. The nodes exchange communication protocol data to configure specific computer-to-computer connections for the formation of network 350 using the infrastructure of network interfaces and switches provided in network 300. FIG. 2 shows an example of a network 350 formed as a result of execution of the programs from collection 160 output by compiler 103.

The details for compiler 103, nodes 202, 203, and details of the formation of a network 350 are further described below. The description is divided into four sections. The first section presents details of compiler 103, the second section describes the apparatus nodes 202 and 203 and the third section describes overall operation comprising the process of code compilation using compiler 103 and execution of the compiled code using nodes 202 and 203 resulting in the formation of network 350. The fourth section summarizes meanings for a few commonly used technical terms in the description.

A few variants of the embodiment are also described following a primary embodiment for each aspect of the invention.

### 1. Code Compilation for Dynamic, Optionally Peer-to-Peer, Networks

Generally speaking, a compiler may correspond to a software application (a set of computer-executable instructions) that is configured to translate or transform a set of input computer programs (or source codes) into object or machine-executable code. The object or machine-executable code may be represented in the form of instructions and data suitable for processing by a target computer or computing architecture. Abstractly, a target computing architecture may comprise of a set of computers or computing devices connected together in a network.

Traditionally, a compiler is presumed to know the details of the target computing architecture at the time of code compilation and the architecture is assumed not to change during the execution of the compiled code. A dynamic, optionally peer-to-peer, network 350 as a target architecture for a compiler differs in this aspect to the traditional expectations. The details of network 350, such as size of the network, the type of devices in the network, the inter-connections in the network (or network topology) may not be known at the time of code compilation, and can dynamically change during the execution of the compiled code.

A dynamic network 350 allows computing devices to join and leave the network as nodes at any time. Furthermore, such a network allows the formation of new inter-connections between nodes or allow the removal of existing inter-connections at any time, thus changing the network topology. Such dynamic changes defy traditional expectations of a compiler and make the use of a typical compiler to generate code for such networks impossible without additional effort from a human programmer to account for such changes within the input source code.

An object of the present invention is to eliminate the additional effort required from a human programmer to account for a changing network within the input source code by allowing a compiler to automatically generate the required changes in the compiled code.

Another object of the present invention is to exploit the opportunity presented by a dynamic, optionally peer-to-peer, network 350 to dynamically change the network details, such as size, type of devices and network topology, in response to the requirements of an input program or program data. Such responsiveness to changing program requirements by changing the network details during execution can be achieved automatically by the compiled code of the present invention without additional programmer effort to modify the input source code or code recompilation.

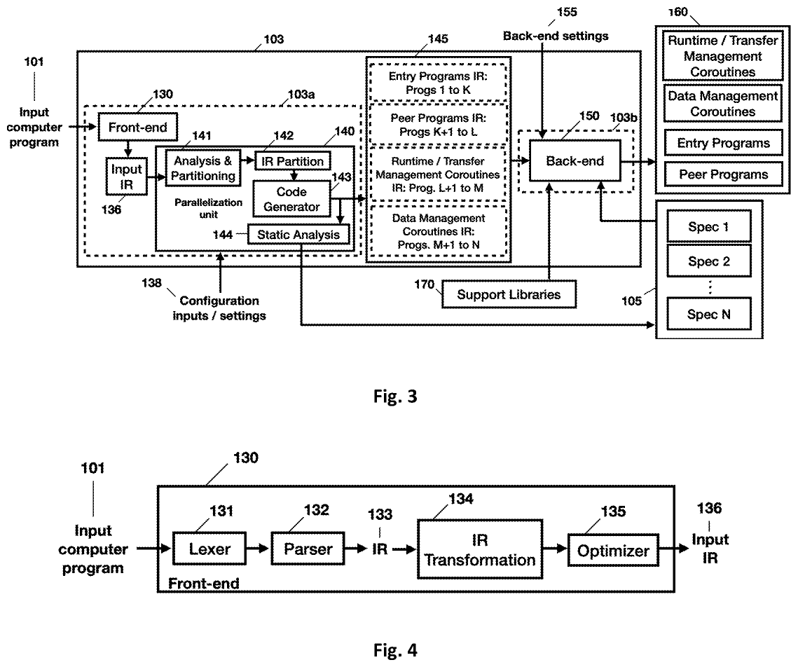

An illustrative compiler embodiment supporting the above aspects of the invention is shown in FIG. 3. The embodiment for compiler 103 comprises of a front-end unit 130, a parallelization unit 140, and a back-end unit 150. Front-end 130 receives an input source code or computer program 101 and outputs an intermediate representation 136 of the input source code.

Parallelization unit 140 receives intermediate representation 136 as an input and outputs a collection of inter-dependent computer programs 145 and a corresponding collection of program specifications 105. Specifications 105 encode the input and output data dependencies between the programs in collection 145. In one embodiment, specifications 105 may additionally specify estimates of computational, memory and communication workloads of programs in collection 145, and may also specify software dependencies, network topology (i.e. connectivity requirements between nodes in a network) or hardware requirements for programs in collection 145.

Compiler back-end 150 receives programs from collection 145 and corresponding specifications from collection 105 and transforms the received programs to a collection of computer executable programs 160. In another embodiment, back-end 150 may produce more than one version of an executable for a program from collection 145 to support execution on different device types or target architectures. Further, a set of instances of back-end 150 may process the programs in collection 145 and output the collection of executable programs 160, with at least one executable counterpart to every program in collection 145. Target architectures or device types on which generated code 160 should be executable are specified to a back-end instance through program specifications 105 or through a settings input 155 to back-end 150.

The back-end may further combine or link a program from collection 145 with a set of external software or programs made available from a collection of programs or support library 170 to create an executable program in collection 160. The programs to be linked may be specified using specifications 105 or through a specification in back-end settings 155.

The programs in collection 145 may be output in an intermediate representation (IR) form similar to that of input IR 136 or in other embodiments as computer code in a high-level language such as C or C++ or assembly code or as machine readable bit-code or object code. Specifications 105 may be embedded as data in the computer programs in collection 145 or as separate computer files or both.

The details of the program or code generation process for collection 145 are further detailed in section 1.2. As part of the code generation process, code generator 143 may insert instructions in the programs in collection 145 to add or remove nodes to or from a network 350, to distribute programs from collection 145 or 160 to new nodes, send and receive program data, or to initiate execution of programs from collection 160 on newly added nodes. The added instructions enable the dynamic and self-organized formation or configuration of a network 350 for executing programs in collection 160.

Parallelization unit 140 marks a set of executables in collection 160 as entry or starting points or entry programs for the execution of programs in collection 160. The entry programs initiate execution on a set of nodes within a network 300 and initiate the network formation process for network 350 and the further execution of programs in collection 160 using nodes in network 350.

The computers in network 300 are able to connect to a set of instances of a computer or server 200 running a peer-discovery-node 202, exemplified by an instance running on computer S1 in FIGS. 1 and 2. The computers in network 300 can exchange connection messages through a peer-discovery-node 202 to establish peer-to-peer or bidirectional or fully duplex communication links between the linked computers. The details of peer-discovery-node 202, computer network 300 and the message exchange to form direct peer-to-peer communication links are described further in section 2 below. These elements are introduced here only briefly to provide context for the operations performed by compiler and the compiled code execution.

The formation of a peer-to-peer communication link eliminates the need for a peer-discovery-node 202 for further communication between the computers linked by such a link. Thus, a set of computers from a configurable network 300 may be connected to form a new peer-to-peer network 350. The programs in collection 160, especially the entry programs, may contain instructions inserted by parallelization unit 140 that result in the exchange of messages through a peer-discovery-node 202 and the formation of a network 350. The programs from collection 160 can then further add or remove nodes from network 350 with instructions inserted by the compiler for this purpose. The programs in collection 160 may thus self-organize and dynamically create and manage a peer-to-peer network 350 during execution. The details of the algorithms by which parallelization unit 140 marks programs as entry points or inserts the additional instructions into a program are further described below.

The compiler front-end 130, parallelization unit 140 and back-end 150 may be implemented as a software application or as separate software applications, and executed on a set of instances of a computer 102. Such a computer 102 may itself be part of the network of computers 300.

In one embodiment of the compiler, an instance of back-end 150 is present on every node in network 300 and a set of programs from collection 145 are received by back-end instance on a node and transformed into corresponding executables and stored locally in a memory assigned on the node for execution. In another embodiment, back-end 150 is executed on a computer 102 generating a collection of executables 160. The collections 160 and 105 are then expected to be transferred to a set of nodes in network 300 for execution.

The components 130, 140 and 150 of compiler 103 are described below with further details.

### 1.1. Front-End Unit

A compiler front-end 130 reads in an input computer program 101 and performs a sequence of transformations on the input, such as lexical analysis (lexing), syntax analysis (parsing), code generation and code optimization, to output an intermediate representation 136 of the input program. FIG. 4 shows an embodiment of front-end 130.

The first operation in the embodiment is that of lexical analysis (or lexing). A lexing unit or lexer 131 reads input computer program 101 as a sequence of characters or symbols or bytes (8 binary bits) of memory. The sequence of characters is transformed by lexer 131 to a sequence of character groups using a finite state machine implemented in algorithmic form. Each character group is assigned a token or group type indicator by the finite state machine, which characterizes the group with a special meaning such as a numeric value, or a variable name, or a keyword in the programming language. The design of the finite state machine (FSM) is determined by the specifications of the programming language and the details of constructing a FSM for the lexer given the language specification can be found in reference books such as “Compiler Design: Theory, Tools, and Examples” by Seth D. Bergmann, Rowan Digital Works, Open Educational Resources; or “Engineering a Compiler” by Kieth Cooper and Linda Torczon, Elsevier; the contents of which are incorporated herein by reference.

The second operation, parsing, performed by a parser 132, transforms the sequence of character groups to an intermediate representation (IR) 133 describing the syntactic and semantic information contained in input program 101. A pushdown automaton can be constructed as a software application given the language specifications for the input computer program's programming language to effect such a transformation. The details of constructing such an automaton for the parser can be found in the abovementioned references along with examples and algorithms. Multiple lexer-parser input chains with different constructions may be included in the front-end to support different programming language inputs.

Intermediate representation 133 may include a set of data structures that represent the structure and semantic content of source code 101, such as syntax trees, graphs, symbol tables or other suitable data structures. The intermediate representation may also include additional annotation information generated through the parsing and analysis of input program 101. For example, the intermediate representation may include control flow graphs or data flow graphs that explicitly identify the control and data relationships among different blocks or sections of input program 101. Such sections, control or data-flow information may be generated and employed by parallelization unit 140 to determine, for example, how functional portions of input program 101 may be rearranged (e.g., by optimizer 142) to improve performance while preserving necessary execution-ordering relationships within the input program 101.

Intermediate representation 133 output from parser 132 may be output as the final intermediate representation output 136 of front-end unit 130. The front-end unit may however also include a chain of additional IR-transformation 134 and optimization 135 blocks that perform further transformations and optimizations on the intermediate representation. For example, an IR transformation block 134 may be included to transform a syntax tree intermediate representation to a stack code or single static assignment code form of intermediate representation. The intermediate representation may also be optimized by a set of optimization blocks performing optimizations such as vectorization, loop optimization (e.g., loop fusion, loop unrolling, etc.), data flow optimization (e.g., common subexpression elimination, constant folding, etc.), or any other suitable optimization techniques. Examples and algorithms for the abovementioned IR transformations and optimization techniques can be found in the reference, “Engineering a Compiler” by Kieth Cooper and Linda Torczon, Elsevier.

If blocks 134 or 135 are included in the front end, the intermediate representation output of the last block in the chain is output as the intermediate representation output 136 for front-end 130.

Intermediate representation 136 may directly be input to a back-end 150 to generate a sequential executable code corresponding to the input program that can be run on a computer. The parallelization unit 140 described below modifies and adds to the intermediate representation to generate a collection of separated, interdependent programs 145 that may be executed in parallel while self-organizing a dynamic network 350 for the execution.

### 1.2. Parallelization Unit

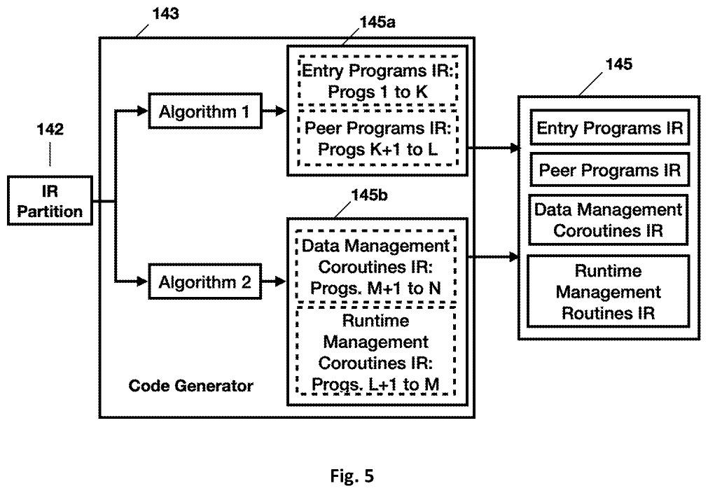

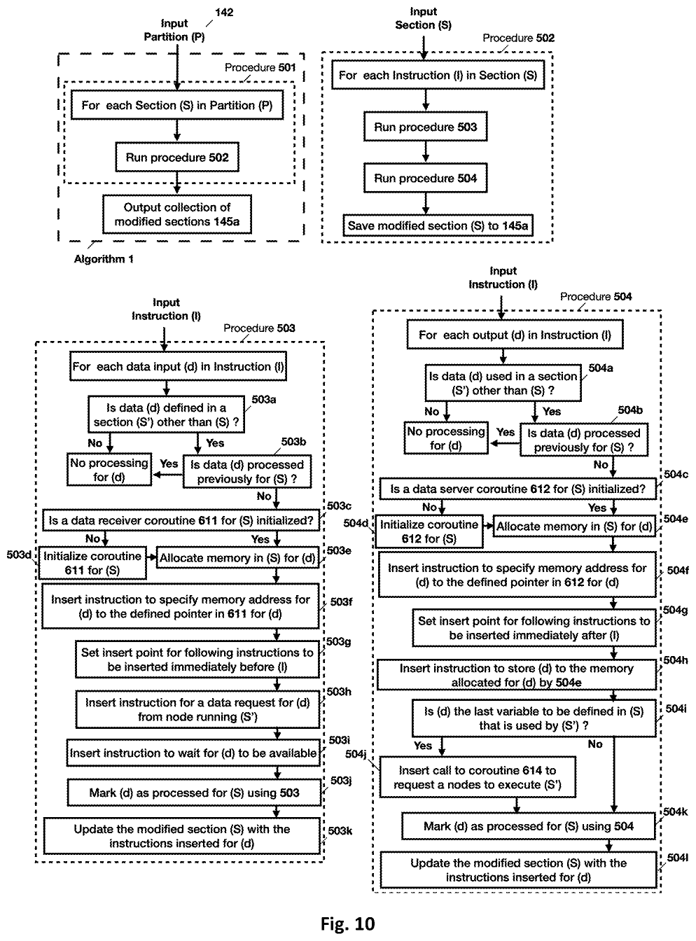

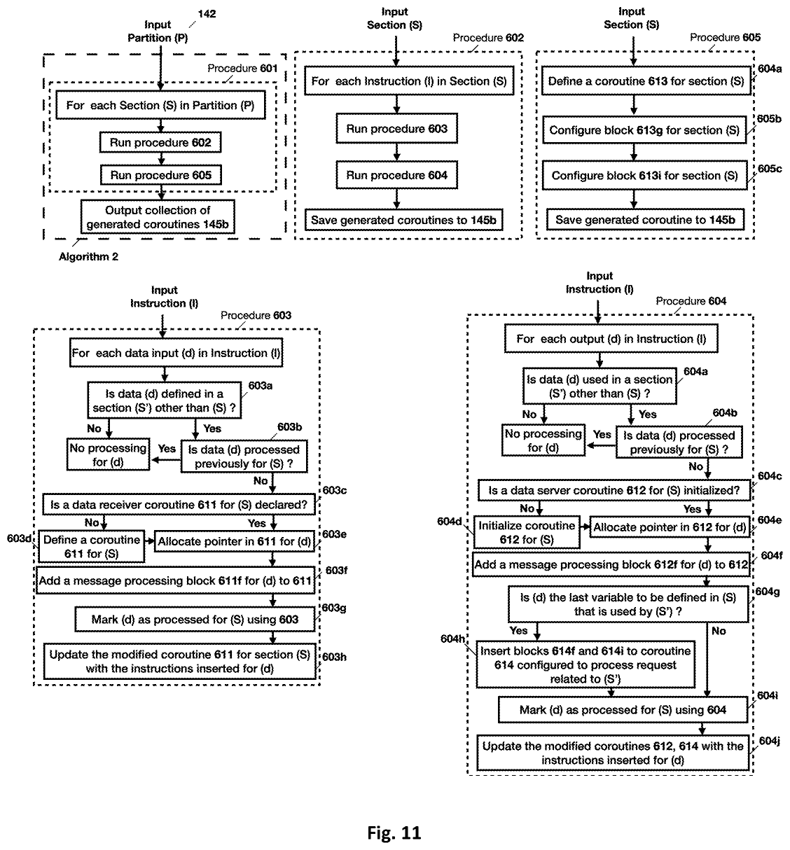

FIG. 3 shows a simplified schematic of the internals of parallelization unit 140. Parallelization unit 140 receives an input program's intermediate representation 136 and performs static analysis and code partitioning using techniques of data-flow and control-flow analysis and graph partitioning, to output a partitioned version of the program's intermediate representation 142. The IR partition 142 is input to a specialized code generator 143 to output a collection of programs 145 and program specifications 105. The internals of code generator 143 are shown using FIG. 5, wherein code generator 143 executes algorithms 1 and 2 (shown in FIGS. 10 and 11 as flowcharts) to generate collection 145.

Techniques and algorithms for static analysis of code, including tasks like finding inputs and outputs for a block of code, data-flow or control-flow analysis are presented in reference books “Static Program Analysis” by Anders Moller and Michael I. Schwartzbach, Department of Computer Science, Aarhus University, Denmark; and “Principles of Program Analysis” by Flemming Nielson, Hanne Riis Nielson and Chris Hankin, Springer; and “Engineering a Compiler” by Kieth Cooper and Linda Torczon, Elsevier; the contents of which are incorporated herein by reference.

Similarly, examples and algorithms for performing code partitioning to output a code partition 142 can be found in works like Michal Ciszewski and Konrad Iwanicki, 2017, “Efficient Automated Code Partitioning for Microcontrollers with Switchable Memory Banks”. ACM Transactions on Embedded Computing Systems, Volume 16, Number 4, Article 114 (September 2017); or Pourmohseni, Behnaz, Michael Glaß, Jörg Henkel, Heba Khdr, Martin Rapp, Valentina Richthammer, Tobias Schwarzer, Fedor Smirnov, Jan Spieck, Jürgen Teich, Andreas Weichslgartner, and Stefan Wildermann. 2020, “Hybrid Application Mapping for Composable Many-Core Systems: Overview and Future Perspective”, Journal of Low Power Electronics and Applications 10, no. 4:38.

Code partition 142 identifies and separates an intermediate representation 136 into parts or sections that can potentially be executed in parallel without affecting the correctness of results of the computer program it represents. Such parallel execution can result in acceleration of the program execution and/or scaling of the program functionality to process several data inputs or instructions in parallel using the additional resources available in a network of computing devices such as network 300. The instructions executing in parallel however may have data dependencies on results from other instructions and are required to wait until such data is ready, thus enforcing a data inter-dependency between the sections identified in partition 142. The inter-dependencies are identified using static analysis, and output as a part of program specifications 105, wherein each section in partition 142 is assigned a unique label and its dependencies on other sections is represented using a suitable data structure such as a dependency graph.

Partition 142 is further transformed by a code generation unit or code generator 143 using algorithm 1, shown as a flowchart in FIG. 10. Algorithm 1 inserts program instructions in a set of sections identified in partition 142, with instructions to:
i. request computational resources or peer nodes from a resource-interface-node 203 and peer-discovery-node 202 to execute a set of sections in partition 142, or,
ii. establish or configure communication links between a set of nodes in a network 300 to form and add nodes to a peer-to-peer network 350, or,
iii. send a set of programs from program collections 145 or 160 or 170 to nodes in network 350, or,
iv. initiate execution of a set of programs on a computational node in network 350, or
v. send data to or request data from nodes in network 350, or,
vi. wait for requested data to be received from nodes in network 350

Algorithm 1 transforms partition 142 with insertions of new instructions outputting a collection of programs 145a. Code generator 143 also processes partition 142 to generate new programs 145b using algorithm 2. FIG. 11 shows algorithm 2 as a flowchart. The collections of programs 145a and 145b put together is output by parallelization unit 140 as the collection of programs 145.

Algorithm 2 analyses inter-dependencies between programs in partition 142 to generate the additional collection of programs 145b, comprising of programs to:
i. respond to data requests from peer nodes in network 350
ii. receive and process data received from peer nodes in network 350
iii. request resources from networks 300 or 350 to transfer the control and processing of a program in collection 145 or 160 to a new node
iv. send program code and execution data to initiate execution or transfer execution of program from one node to another
v. perform runtime analysis of computational workload or data size being processed by a program and select the number and type of computational resources to acquire for the program in network 350

The partitioning algorithm, and algorithms 1 and 2 used for program transformations by parallelization unit 140 are described below in further detail.

### 1.2.1. Description of IR Partitioning

The analysis-and-partitioning-unit 141 processes input IR 136 using a graph partitioning algorithm to produce an IR partition 142 comprising of several parts or sections or code sections into which the original input IR 136 gets divided.

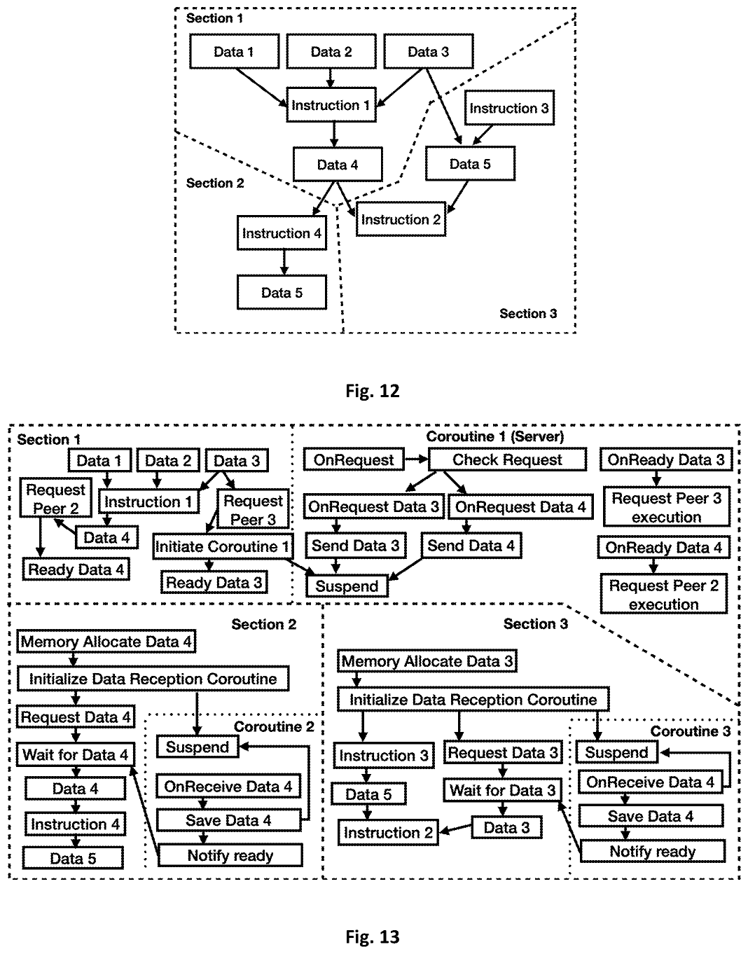

The inter-dependencies between the parts or sections of partition 142 are easily visualized with a data-flow graph representation. FIG. 12 shows an example of a partitioned IR as a data-flow graph for illustration. The actual data structure used for intermediate representation 142 however need not be a data-flow graph, but may instead also be any other suitable form such as syntax trees or stack code or single static assignment code form. The data-flow graph form of an IR is shown in FIG. 12 for its relative ease for visualization.

Each part or section of partition 142 is a sequence of instructions to be executed on a computer. An instruction may be a source type, a sink type or an intermediate type. A source type instruction is one that depends on no data inputs for its execution but may generate data as its output upon execution. A sink type instruction is one which creates no data as its output upon execution but may depend on some input data. An intermediate type instruction is one which both depends on data inputs for execution and generates data output upon execution. A data inter-dependency is created between two sections of partition 142 whenever an instruction in one section requires input data existing or generated in another section. A data inter-dependency between two sections can be visualized in a data-flow graph of the partition, such as that exemplified in FIG. 12, as edges of the graph or arrows that point from one section to another in the partition.

A source type instruction may be for example an instruction that loads data from some given location in memory or a given file or from a given link on the internet, or accepts user input from an input device such as a keyboard or mouse or other such input devices or interfaces to a computer, or outputs data from a random data generator, amongst other such instructions that may generate or load data to be used further in partition 142.

A sink type instruction may be for example an instruction that saves data to some given location in memory or file or link on the internet. A sink type instruction may further be instructions such as a branch, conditional branch or jump instruction which may direct the program to change the next set of instructions to execute, thereby implementing features required for control-flow in the program. We include instructions that require no data input and produce no data output but simply affect the control flow such as simple branch or jump or unconditional branch like instructions under the nomenclature of sink type instructions, as the instructions still depend on data outputs from previously executed instructions if only to encode the order of execution in which such branch or jump or other such no-input-no-output should appear and execute in the program represented in partition 142. All other instructions that take both input and output data are assigned under the nomenclature of intermediate type instructions.

In one embodiment of the partitioning algorithm, a partition 142 may be generated by dividing the input IR 136 with a random selection of divisions to separate the code into the sections for the partition. The partitioning algorithm then assigns a numerical value or cost value or quality metric value to the selection of the divisions used for the partition. Such a numerical value may be computed using an objective function for an optimization algorithm, taking into account workload balancing between the sections, number of interdependencies between the divisions or other such criteria. An optimization or iterative update algorithm can then update the choice for divisions to improve the valuation assigned by the objective function to the selected division of sections for the partition. The optimized partition output can then be provided as IR partition 142.

The optimization algorithm and objective function valuation may depend on several numerical parameters or configuration settings, which may be supplied using a configuration or settings input 138 provided for parallelization unit 140.

The IR partition 142 may also be influenced by the use of compiler directives or other programming language features that require or indicate preference for certain blocks or lines of code to be grouped together in a single section of the partition. The directives and other such programming features are embedded in input IR 136 by the compiler front-end 130 and may be implemented in the optimization algorithm as constraints to encode strict requirements for groupings or as part of the objective function to encode preferences for such groupings.

### 1.2.2. Description of Partition Processing Algorithms 1 and 2

Code generator 143 processes IR partition 142 generated by analysis-and-partitioning unit 141 using two partition processing algorithms, denoted as algorithm 1 and algorithm 2 in FIG. 5. Algorithm 1 processes the sections in partition 142 by inserting new instructions into a set of sections of partition 142. Algorithm 2 adds new sections to the partition in the form of new programs or coroutines to support the functions of data and runtime resource management.

FIG. 13 shows the outcome of the processing of the partition example shown in FIG. 12, after processing by algorithms 1 and 2. FIG. 13 however limits the visuals to depict only data-management coroutines generated by algorithm 2 to limit the visual complexity. Node-transfer and runtime-management-coroutines 613, 614 that may be generated by algorithm 2 for the example are excluded from FIG. 13.

### 1.2.2.1. Description of Algorithm 1

An embodiment of algorithm 1 is shown in FIG. 10 as a flowchart. Algorithm 1 takes as input the partitioned IR 142 and processes each section in partition 142 using a computer-implement procedure 501. Procedure 501 processes partition 142 by performing for each section in 142 a further processing procedure 502. Procedure 502 processes all the inputs and outputs to a section (S) in partition 142 by performing for each instruction in section (S) further processing procedures 503 and 504.

### Processing Input Dependencies (Procedure 503)

Procedure 503 processes all the inputs to an instruction (I) from a section (S) by performing for each data input of instruction (I) the following processing steps. The first processing step 503a checks if data input (d) under consideration is a data or control-flow dependency on a data or code object (d) defined in a section (S′) other than section (S). If data input (d) does not have a dependency on any data or code object from such a section (S′), no further processing steps are performed for data (d) and procedure 503 continues on to consider the other data inputs of instruction (I).

If data input (d) is a dependency on a data or a code object (d) from a section (S′) other than section (S), then procedure 503 inserts a set of new instructions for data (d) using steps 503c-k. Step 503c checks to see if an instruction to initialize a data-receiver coroutine 611 (described further below) has already been inserted to section (S). If coroutine 611 is not already initialized in section (S), step 503d inserts an instruction in at the beginning of section (S) to initialize a receiver coroutine 611 for section (S) and the procedure proceeds to step 503e.

If an instruction to initialize coroutine 611 is already inserted to section (S), step 503d is skipped and step 503e is directly performed. Step 503e inserts an instruction immediately after the instruction initializing coroutine 611 in section (S). Step 503e inserts an instruction to allocate a shared memory to store data (d) to section (S), with the memory being shared with coroutine 611. The next step 503f inserts an instruction in section (S) immediately after the instruction inserted by step 503e. The instruction inserted by step 503f sets a pointer for data (d) allocated in coroutine 611 by algorithm 2 to hold the address for the memory allocated for data (d) in section (S).

Next, step 503g sets the insert point for processing such that the sequence of instructions inserted by the next steps 503h-i are inserted immediately before the instruction (I) in section (S). The new instructions are inserted such that the instruction inserted in step 503h comes before the instruction inserted by step 503i.

Processing step 503h inserts an instruction to request for the data or code object (d) from an instance of a resource-interface-node 203. The instruction inserted by step 503h relies on a method 802c and a resource manager 801 of resource-interface-node 203 described in section 2, to direct the message for data (d) request to a node executing section (S′) during program execution on a dynamically formed network 350.

Processing step 503i then inserts an instruction to wait or pause or suspend execution of section (S) till resource-interface-node 203 responds with a signal indicating the availability of data (d) in the allocated memory. The signal for availability of data (d) is provided to the instruction inserted by step 503i by data-receiver coroutine 611 configured by algorithm 2 as described below.

Finally, a step 503k merges the changes made by the insertions made to section (S) for instruction (I) and data input (d) with other changes made for other instructions or data inputs in section (S), to save a common modified version of section (S) to be output by procedure 503.

Additional processing steps 503b and 503j may be included in an embodiment of procedure 503 to prevent the inefficiency of inserting multiple memory allocation, request and wait instructions for the same dependency (d) in a section (S). Processing step 503b is performed after step 503a and before step 503c. Step 503j is performed immediately after step 503i and before step 503k.

When included, step 503b checks if the dependency on data (d) is being processed more than once for a section (S). After executing steps 503c-l, processing step 503j saves a unique identifier for data (d) from IR 142 to a list (L) of dependencies processed for section (S) by procedure 503. Step 503b can check list (L) to check if a dependency has been previously processed for section (S) by procedure 503, if yes, processing steps 503c-k are skipped to avoid multiple insertions of the same instructions, otherwise steps 503c-k are performed as described above. Step 503j records or marks a dependency on data (d) as being processed for section (S) by step 503j by saving the identifier for data (d) to list (L) when 503c-k are performed. List (L) is initialized as an empty list for each section (S) in initialization of procedure 501 for section (S) and then used by steps 503b, 503j.

### Processing Output Dependencies (Procedure 504)

Similar to procedure 503 which processes the inputs to an instruction (I) in section (S), procedure 504 processes the outputs of an instruction (I). Procedure 504 processes an instruction (I) by performing for each output data (d) of instruction (I), further processing steps 504a-l. Step 504a checks if an output (d) under consideration is an output from section (S) to another section (S′), i.e., if an instruction in another section (S′) depends on or uses data (d). If no such dependency on data (d) exists, no further processing steps are performed for output (d) and procedure 504 continues on to consider the other outputs of the instruction (I).

If output (d) is indeed an output from section (S) to another section (S′), then procedure 504 inserts a set of new instructions for data (d) to section (S) using steps 504b-l. For each section (S), a list (L′) is initialized as an empty list within initialization of 501 for section (S). After processing an output (d) using steps 504c-k, step 504k marks output (d) as being processed by procedure 504, by saving an identifying label for data (d) from IR 142 into list (L′).

If step 504a determines data (d) to be an output of section (S), then step 504b checks if data (d) has been already processed by procedure 504 using (L′). If data (d) has been already processed by procedure 504, no further processing of data (d) is performed and procedure 504 continues with processing of other outputs of instruction (I). If data (d) has not been already processed by procedure 504, further processing steps 504c-l are performed for data (d).

Step 504c checks if an instruction to initialize a data server coroutine 612 instance (c) is already inserted in section (S), if not, step 504d inserts such an instruction at the beginning of section (S). Step 504e inserts an instruction immediately after the instruction initializing coroutine 612 in section (S). Step 504e inserts an instruction to allocate a shared memory to store data (d) to section (S), with the memory being shared with coroutine 612. The next step 504f inserts an instruction in section (S) immediately after the instruction inserted by step 504e. The instruction inserted by step 504f sets a pointer for data (d) defined in coroutine 612 to hold the address for the memory allocated for data (d) in section (S).

Step 504g sets the insert point for processing such that the instructions inserted by steps 504h-k are inserted immediately after instruction (I) in section (S) in the order given by the step order of steps 504h-k. Step 504h inserts an instruction to store a copy of the output (d) from instruction (I) to the memory allocated by step 504e for data (d).

Step 504i checks if data (d) is the last dependency of section (S′) on section (S). If yes, step 504j inserts an instruction to call a runtime-management-coroutine 614 configured to request computational resources or nodes for executing a set of copies of section (S′). Coroutine 614 looks up the number of copies of section (S′) that need to be executed from program specifications 105 available at runtime and accordingly calls a resource-interface-node 203 method 809b to request the computational resources or nodes for executing copies of section (S′).

Coroutine 614 is configured by step 504j to look up the specifications for section (S′) available at execution time from the compiler's specifications output 105 and call a resource-interface-node method 809b with an advertisement message 806a containing the specifications for section (S′) and its coroutines. Message 806a may be configured as part of a message data structure 614b defined in coroutine 614 and method 809b is called by an instruction in a code block 614f in coroutine 614. Method 809b checks with a peer-discovery-node 202 to see if section (S′) has been already allocated nodes, if yes, the details for the allocated nodes are returned by method 809b to a coroutine block 614i in coroutine 614 and execution of section (S′) is requested on the allocated nodes.

If a node is not already allocated for section (S′) method 809b sends out an advertisement message 806a (configured by an instruction inserted by step 504j) to a peer-discovery-node 202 and acquires the required allocation of nodes. The information for the allocated nodes is then returned to coroutine block 614i and gets stored in the runtime memory for the program running for the coroutine and execution requests are sent to the allocated nodes. Further details of method 809b, advertisement message 806a and the acquisition of nodes from a network using the node 202 are described in section 2. If data (d) is not the last dependency of section (S′) on section (S), step 504j is skipped for data (d) and step 504k is executed directly.

The next step 504k, marks data output (d) as processed by procedure 504 and finally, step S041 merges the changes made by the insertions made to section (S) for instruction (I) and output (d) with other changes made for other instructions or output in section (S), to save a common modified version of section (S) to be output by procedure 504. The output from procedure 504 then contains all modifications to section (S) made by procedures 503 and 504 and is output as part of the collection of programs 145a that corresponds to section (S) of partition 142.

The programs generated by algorithm 1 can further be subjected to optimization in the IR form using an optimizer similar to optimizer 135 used in front-end 130, and output to collection 145a in their optimized form.

The details of coroutines 611, 612, 614 are further described below in details of algorithm 2 and the details for methods called by coroutine 614 are described below in section 2.

The processing of all the sections, instructions, inputs or outputs using procedures 502-504 as described above are shown in FIG. 10 as iterative loops in a flowchart. The processing of all sections, instructions, inputs or outputs however may also be implemented in a different order or as independent parallel processes exploiting the independence of the processing steps in the procedures and not necessarily as an iterative loop process as shown in the flowchart for simplicity.

The output of algorithm 1 is the modified partition 145a, with the insertions of instructions as performed by algorithm 1. The sections from partition 142 that require no input from any other section in partition 142 are called entry sections in partition IR 142. The modified section generated by algorithm 1 for such entry sections is labelled as an entry program IR by the static analysis unit 144. The labelling may be performed by adding an appropriate metadata label to the IR in output 145a or as metadata labels stored in specifications 105. In another embodiment, code generator 143 may generate the programs for the sections in output 145a as coroutines with additional instructions available to suspend and resume the coroutines.

The sections in output 145a that are not entry sections, i.e., that do depend on other sections for inputs, are labelled as a peer program IR. For the purposes of execution of the generated programs on a network 350, programs labelled as entry programs are required to be initiated for execution by the user of the programs by initializing their execution on a set of compute nodes in a network 300. Peer programs on the other hand are automatically executed by entry programs or other peer programs using the instructions inserted by algorithm 1 to call runtime-management-coroutines 614. Compute nodes from network 300 are automatically obtained for the execution of programs in output 145a forming network 350. The operation and details of execution of such programs on network 350 are further described below in section 3.

### 1.2.2.2. Description of Algorithm 2

In addition to inserting instructions into the code sections of IR partition 142, as done by algorithm 1, code generator 143 also creates entirely new code sections to add to the output partition 145 using algorithm 2. The newly generated sections correspond to coroutines that may be used for data, network or execution management on network 350. The coroutines referenced in algorithm 1 such as coroutines 611, 612 and 614 are amongst the coroutines generated by algorithm 2. FIG. 11 shows a flow chart form for algorithm 2 and is described in detail below.

Algorithm 2 takes as input the partitioned IR 142 and generates additional coroutines to support execution of partitions in a responsive and dynamic network such as network 350. The algorithm (algorithm 2) processes each section (S) in partition 142 using a procedure 601. Procedure 601 processes each instruction (I) in a section (S) using procedure 602. Procedure 602 utilizes further procedures 603 and 604 to process inputs and outputs of instruction (I) respectively. Finally, procedure 615 configures a coroutine 613 to manage runtime requests to transfer execution of a section (S) from one computing node to another in a network 300.

### Processing Input Dependencies (Procedure 603)

Procedure 603 processes each data input (d) of an instruction (I) under consideration as follows. First, a step 603a checks if data input (d) under consideration is a data or control-flow dependency on a data or code object (d) defined in a section (S′) other than section (S), if yes, further processing steps 603b-h are undertaken for input (d), if not, no further processing of data (d) is required and procedure 603 continues processing other inputs of instruction (I).

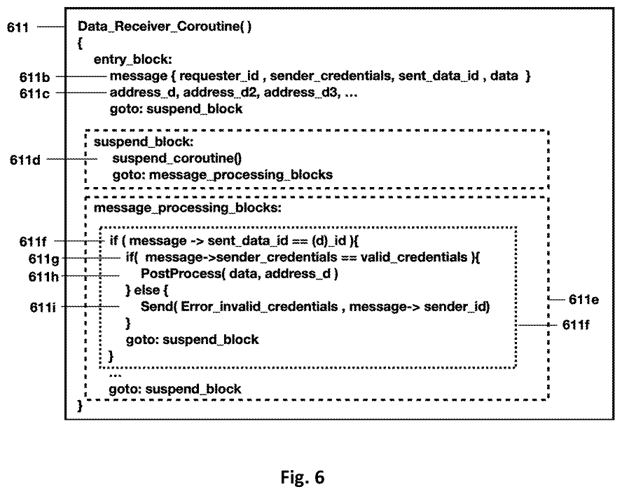

Step 603b checks if an input dependency (d) for an instruction (I) has been already processed by procedure 603, if yes, then further processing steps 603c-h are skipped and procedure 603 continues processing other inputs to instruction (I). If data (d) is not already processed, step 603c checks if a coroutine 611 has been declared for a data receiver for section (S) under consideration, if not, step 603d declares a new coroutine (c) for a data receiver for section (S) using a code template 611 shown in FIG. 6.

The coroutine code template 611 contains three blocks of code. The first block is the entry block for the coroutine function which gets executed when an instance of the coroutine is first called or initialized. Such an instruction to initialize a data receiver coroutine is inserted in section (S) by processing step 503d in algorithm 1. The entry block defines the variables used in the coroutine and allocates pointers to shared memory for data to be shared between the program generated for section (S) by algorithm 1 and supporting coroutine 611 generated by algorithm 2 for section (S). After defining variables 611b, 611c the entry block runs an instruction to execute the second block, which is the suspend block. The suspend block executes an instruction 611d to pause or suspend execution of coroutine 611, wherein the coroutine returns to the parent calling process after being suspended and no further instructions from coroutine 611 are executed until coroutine 611 is un-paused or called again by some other external process. Coroutine 611 continues execution from the instruction after the suspend instruction when un-paused after a previous suspend call.

The receiver coroutine 611 is called by resource-interface-node 203 whenever a new message containing some data is sent to a computing node executing the code for section (S). The received message is saved by node 203 to an allocated shared memory 611b in coroutine 611. The coroutine after such a call from node 203 gets un-paused and processes the received message using a third message processing block 611e. Code block 611e contains several instances of data processing blocks of type 611f inserted into coroutine 611 using step 603f in algorithm 2.

The coroutine template is configured to the specifics of a section (S) using steps 603e-f. Step 603e inserts an instruction in template line 611c to allocate a pointer to the address at which data (d) is stored in the program executing section (S). Algorithm 1 allocates the shared memory for (d) in(S) and stores the memory address to the corresponding variable in declared in line 611c during the coroutine initialization. Algorithm 1 and 2 can refer to common shared variables using a common identifier label derived from the IR identifier for data (d). The common identifier in line 611c and for algorithm 1 may be obtained by appending a predefined prefix or suffix patterns to the IR identifier for data (d).

Then step 603f inserts a message processing code block 611f for data (d) in coroutine 611 instance for(S). Processing block 611f is configured by step 603f to execute conditionally if data (d) is sent to the coroutine as part of a message. Block 611f contains an instruction 611h to process and save the received data (d) to the shared memory allocated for data (d) during initialization for coroutine 611 in section (S). The processing performed by instruction 611h may be simply to save the received data or to combine the received data with any other data for data (d) using operations such as reduce operations that may have been specified in partition 142 using meta-data labels obtained from analysis unit 141.

Code block 611f may additionally contain an instruction 611g to check the validity of the sending node, for example, an instruction to check a hashed key or credentials token to grant or deny access to update memory for data (d). The sent data is processed and saved to the memory using instruction 611h only if instruction 611g grants access, otherwise an error message 611i may be sent as a response to the sender of the message. In another embodiment, if instruction 611g denied access, the coroutine may silently reject the update by sending no response and making no save. The code block 611f ends with an instruction to jump to the suspend block to suspend or pause the coroutine until the next data update message invokes the coroutine again.

Next, step 603g marks data (d) as having been processed by procedure 603. Finally, step 603h merges the updates to coroutine 611 generated for section (S) with the updates made using procedure 603 for data (d). The details of checking and marking data (d) as already processed using a list (L) initialized by 601 are analogous to the details of the similar processing steps 503b and 503j used in algorithm 1.

### Processing Output Dependencies (Procedure 604)

Procedure 604 processes each output (d) of instruction (I) under consideration as follows. A step 604a checks if output (d) under consideration is used by any instruction in a section (S′) other than section (S), if yes, further processing steps 604b-e are undertaken for output (d), if not, no further processing of data (d) is performed and procedure 604 proceeds to process other outputs of instruction (I).

Next, processing step 604b checks if output (d) has already been processed for section (S) in procedure 604, if yes, then further processing steps 604c-j are skipped and procedure 604 continues with processing other outputs of instruction (I).

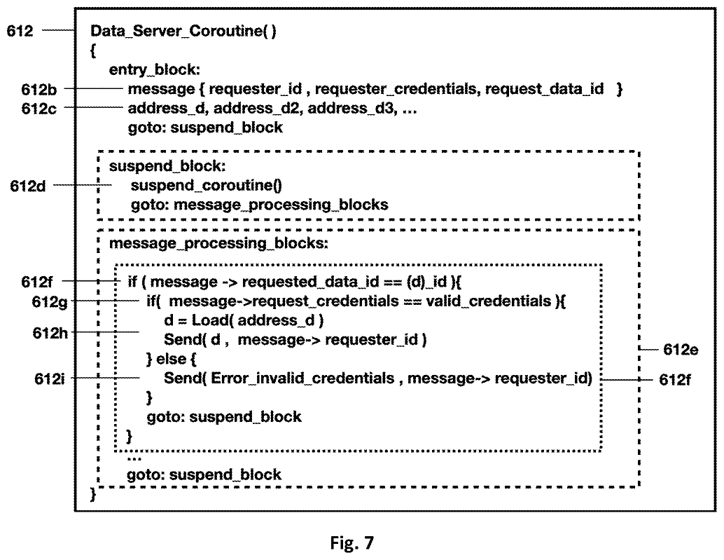

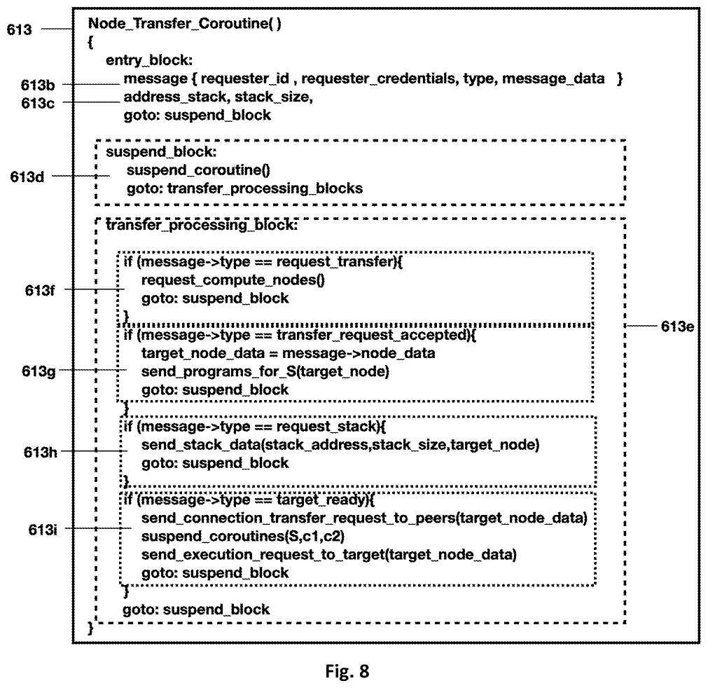

If data (d) is not already processed for section (S) by procedure 604, a processing step 604c checks if a coroutine 612 has been declared for a data server for section (S) under consideration, if not, step 604d declares a new coroutine 612 for a data server using a code template 612 shown in FIG. 7. Next, step 604e inserts an instruction in line 612c to allocate memory to store and specify the address at which data (d) is stored in the program executing section (S). Algorithm 1 initializes a data server coroutine 612 for the executing section (S) using an instruction inserted by step 504d. Algorithm 1 also specifies the address of data (d) and stores it to the pointer variable defined for data (d) in processing step 612c.

After step 604e, step 604f inserts a message processing code block 612f for data (d) into coroutine 612 defined for section (S). Code block 612f is configured by step 604e to execute conditionally if data (d) is sent to the coroutine as part of a message. Block 612f contains an instruction block 612h to load and send data (d) to requesting compute node in network 350 using a method 802c from resource-interface-node 203.

Code block 612f may additionally contain an instruction 612g to check the validity of the requesting node, for example, an instruction to check a hashed key or credentials token to grant or deny access to the memory for data (d). The data is sent to the requesting node using block 612h only if instruction 612g grants access, otherwise an error message 612i may be sent as a response to the requesting node. In another embodiment, if instruction 612g denied access, the coroutine may silently reject the request by sending no response. Code block 612f ends with an instruction to jump to the suspend block to suspend or pause the coroutine until the next data request message invokes the coroutine again.

For a section (S) in partition 142 a set of copies of section (S′) depending on an output (d) may be specified for execution, with the number of copies possibly depending on a data value only available during execution, i.e., unknown during the compilation. Algorithm 2 generates a runtime-management coroutine 614 to determine the number and types of computing devices to request from a network 300 or 350 and initiate the execution of the specified copies of section (S′) on the acquired nodes. The next steps 604g-h concern the generation of coroutine 614.

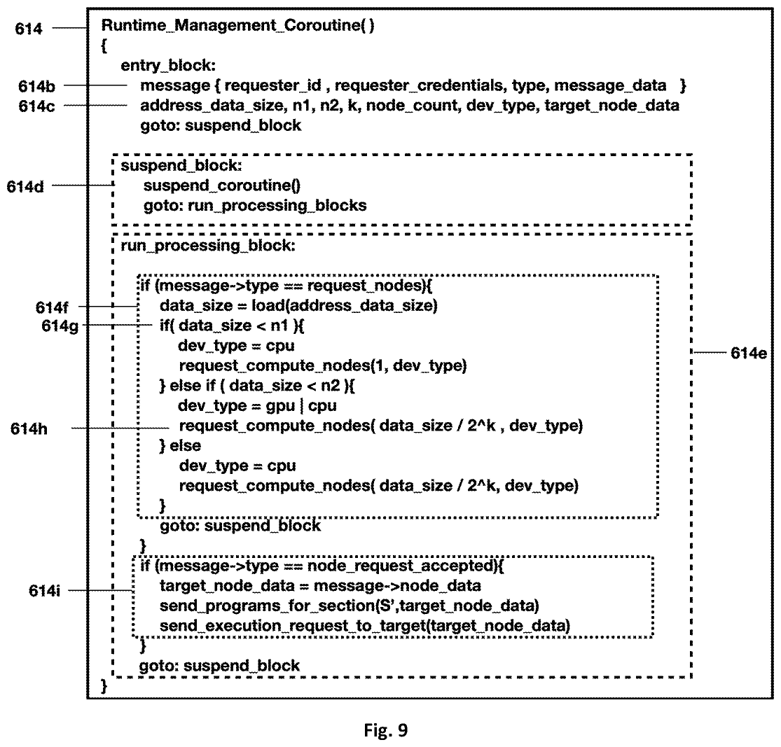

A coroutine template for coroutine 614 is shown in FIG. 9. Coroutine 614 contains an entry block and a suspend block similar to templates 611-613. The entry block contains variables with shared memory that can be read and written to by other calling functions or methods from section (S) or node 203 methods. The suspend block contains can instruction to pause or suspend execution of coroutine 614 until it is un-paused by another instruction in section (S) or from a method in node 203.

Algorithm 1 inserts a call to initialize coroutine 614 in step 504d in a section (S) when it encounters an output going to a section (S′). Algorithm 1 further inserts a call to coroutine 614 in step 504j configured to request computation nodes for section (S′) from network 300 or 350, which triggers the execution of a conditional code block 614f in the coroutine. Code block 614f may be configured by algorithm 2 to request different types and amounts of computation nodes to execute the required number of copies of section (S′), with certain number of copies grouped together to execute on a single node.

The configuration of block 614f may be implemented as conditional blocks of code that run when the size of the data to be processed by the copies of section (S′) meets a size threshold or other such conditions on data size. The conditions for the data size or the respective thresholds for the data sizes may be specified as part of configuration settings 138 for parallelization unit 140. Depending on conditions on processing data size, the code block executed in block 614f may request different number and types of device nodes from networks 300 or 350. The types and number of nodes to be requested for each condition type may also be specified as part of configuration settings 138.

Coroutine 614 is further called by resource-interface-node 203 upon receiving a node accepting the execution of the requested number of copies of section (S′). Such a call from node 203 is processed using a code block 614i. Code block 614i records the information about the accepting target node to its memory, sends the program and coroutines for (S′) to the target node and sends a signal to the target node to begin execution of its copy for (S′). The recorded target data may be shared and used by the coroutines such as the data server and receiver coroutines 611 or 612 to send or request data from the nodes corresponding to each copy of section (S′). The recorded data may include information such as connection information, node identifying labels or node credentials and the unique identifiers from the IR 142 for the subgroup or segments of the copies of section (S′) that are accepted by the node for execution. The recorded data allows the sending or receiving of the correct segments of data to and from the correct nodes executing section (S′).

Step 604g checks if data (d) is the last output from section (S) going to section (S′), if yes, step 604h inserts blocks of type 614f and 614i to coroutine 614 defined for section (S), with the blocks being configured to process requests for resources and execution for section (S′). Coroutine 614 may thus contain multiple blocks of type 614f and 614i corresponding to different output sections (S′) for a section (S). If data (d) is not the last output from section (S) going to section (S′), step 604h is skipped and step 604i is directly performed.

Step 604i marks data (d) as having been processed by procedure 604 and finally step 604j updates coroutines 612 and 614 defined for section (S) with the modifications made for data (d) by the above steps in output 145b.

Algorithm 2 may additionally generate a coroutine 613 to respond to requests for early termination and transfer of execution to another node in network 350. Steps 605a-d are used to configure a coroutine 613 instance for section (S). Step 605a declares a coroutine (k) following a coroutine template 613. Similar to templates 611 and 612, 613 has three blocks. The first block is an entry block that executes when an instance of coroutine 613 is initialized. The entry block contains variables defined containing an address for a message 613b and addresses 613c for a program stack and stack size information for section (S). Node 203 running section (S) initializes the coroutine 613 by specifying the above addresses 613c from the allocated memory resources for the execution of section (S). The stack may contain information or values of the variables defined in section (S). Coroutine 613 jumps to a second block 613d, containing an instruction to suspend or pause coroutine 613. After the coroutine 613 is suspended, it can be un-paused by calling the coroutine or a specific resume function for coroutine 613. After coroutine 613 is un-paused, it resumes execution from an instruction immediately after the suspend instruction. The instruction at the end of the suspend block causes the execution to jump to a third block 613e of coroutine 613 containing instructions to process the transfer of execution of section (S) from one node to another.

Transfer coroutine 613 may be called by resource-interface-node 203 upon request by the user or another program or upon encountering a fault. To initiate a transfer process, node 203 sets the message variable to coroutine 613 to contain a message type corresponding to a transfer request. Code block 613f processes such a request by sending a request using a method 809a from node 203 to a network 300 or 350 for compute nodes to accept the transfer of execution. The request for transfer in block 613f may contain additional information about section (S) such as the specifications for section (S) and its corresponding coroutines defined in specifications 105. After sending the transfer request to nodes 300 or 350 using node 203 the coroutine jumps to the suspend block and section (S) continues execution on its node as normal. If the resource-interface-node 203 receives a message from another node in network 300 or 350 that accepted the transfer request, coroutine 613 is called by node 203 again with the corresponding message data.

A code block 613g is defined in coroutine 613 to process a message accepting the transfer request from node 203. Block 613g saves the node information for the target node that the execution of section (S) is to be transferred to, and step 605b of algorithm 2 configures the instruction in 613g to send program code for section (S) and its coroutines to the target node. The target node after receiving the corresponding data sends a request for the data for section (S), and the stack data is sent by block 613h in response to such a request.

The target node further sends a ready signal or message to the node (n) executing section (S) and coroutine 613 responds to the message using a code block 613i which sends an update message to all the peers connected to node (n) with the target node information. Step 605c then configures the instruction in block 613i to look up nodes for sections (S′) which provide inputs or require outputs from section (S) as the peer nodes to which information about the new target node running section (S) needs to be provided as an update. Code block 603i then suspends the execution of section (S) and its coroutines 611-614 on node (n) and sends a message to the target node to initiate execution of section (S) and it's coroutines on the target node. Block 613i ends with a final suspend for coroutine 613. The initiation and execution of section (S) and its coroutines following the message from block 613i on the target node is further described below in section 2.

The stack data transferred to the target node by block 613h may contain the runtime memory frame of inputs, outputs and internal variables of a section (S) and sends the memory contents to the target node in network 350. Coroutine 613 may be invoked by resource-interface-node 203 as part of its procedure 809a, described below in section 2, to transfer the execution of a section (S) from one computational node to another.

Algorithm 2 terminates after all the sections in partition 142 have been processed as described above. The new sections and coroutines 611-614 generated for the different sections are output as collection 145b. The collections 145a and 145b from algorithms 1 and 2, put together are output by code generator 140 as a collection of output programs 145.

Additionally, code generator 140 processes the programs in collection 145 with static analysis 144 to output the program specifications 105 that contains a specification for the interdependencies of the programs in collection 145 and estimates for the workloads of execution for each program. The inter-dependencies between the entry and peer programs from collection 145a is the same as the interdependencies between the sections in partition 142. The programs in collection 145b are generated for each section (S) in partition 142 separately and a program generated for section (S) is considered to depend on section (S).

The interdependencies between code sections may be specified as a graph stored using an appropriate data structure in specifications 105 with each node in the graph corresponding to a program in collection 145 and directed edges between the nodes specifying the dependencies. Additionally, the nodes and edges or program specification in collection 105 may be labelled with additional information such as estimated computational or memory workloads or estimated communication workloads such as size of data communicated for each dependencies or edges in the graph.

Estimates for the workloads for executing different types of instructions on different device types and communicating different types of data between nodes in a network may use parameters or data inputs for the computation of estimates. The parameters and data inputs are provided to analysis unit 144 using configuration input 138. Specifications 105 may additionally contain specifications for hardware or software dependencies of a section (S).

Finally, the collection of programs 145 and program specifications 105 are output by parallelization unit 140.

### 1.1. Back-End Unit

A back-end unit 150 receives a set of programs from collection 145 presented in an intermediate representation (IR) and translates the programs to a computer-executable, machine or architecture specific format of instructions. The machine specific format may vary from one type of computer to another and the type of translation required is controlled by using a separate embodiment of the back-end for each type. Alternately, an embodiment with multiple translation units for each type of computer supported may be used. The type of translation performed in the latter case may be controlled using a settings input 155 to the back-end. The computer types to be supported by a back-end are called as target architectures.

A back-end may optionally combine or link the input programs to other external programs provided as part of a collection of programs or support library 170. The choice of programs to be linked from collection 170 may also be controlled by settings 155 input to the back-end. Back-end 150 may use translation units and linker tools provided by industry standard compiler frameworks like LLVM that contain a collection of translation and linker tool implementations for various types of computers or computing devices including microcontrollers, microprocessors, multi-core processors and graphical processing units (GPUs), and with an interface to implement and add support for other new types of devices. Description of the LLVM framework and its tools can be found in Chris Lattner and Vikram Adve, 2004, “LLVM: A Compilation Framework for Lifelong Program Analysis & Transformation”, in proceedings of the international symposium on code generation and optimization: feedback-directed and runtime optimization (CGO '04). IEEE Computer Society, USA, 75.

The front-end unit 130 and parallelization unit 140 may output programs in an intermediate representation (IR) used by a compiler framework like LLVM or as a high-level programming language source code like C or C++ that is processable by a compiler toolchain like LLVM's clang. The framework then provides the necessary translation and linking tools for back-end 150.

Alternately, the target architecture for back-end 150 may be an interpreted or JIT programming language's execution environment such as WebAssembly or Julia or Python, or Matlab, or Javascript interpreters. For such interpreted environments, back-end 150 may output code in the interpreted programming language instead of a machine-executable code. The execution software called interpreters for such programming languages will read the output code and execute corresponding machine-executable instructions within the execution software. Examples of such back-ends targeting interpreted languages can be found in works like “Emscripten: an LLVM-to-JavaScript compiler”. 26th Annual ACM SIGPLAN Conference on Object-Oriented Programming, Systems, Languages, and Applications, OOPSLA 2011, part of SPLASH 2011, Portland, OR, USA, Oct. 22-27, 2011; or Javier Cabrera Arteaga, Shrinish Donde, Jian Gu, Orestis Floros, Lucas Satabin, Benoit Baudry, and Martin Monperrus, 2020, “Superoptimization of WebAssembly bytecode”. Conference Companion of the 4th International Conference on Art, Science, and Engineering of Programming, Association for Computing Machinery, New York, NY, USA, 36-40.

Yet another back-end target may be a reconfigurable or programmable hardware device like a field programmable gate array (FPGA). For such a target the back-end may translate the programs in collection 145 to corresponding hardware descriptions in a language like LLVM IR or C or Verilog or VHDL that can be compiled by target-specific compiler tools to configuration files for the reconfigurable or programmable device like FPGA. Examples of such back-end tools can be found in reference guides like “Vivado Design Suite User Guide-High-Level Synthesis” by Xilinx, UG902 version 2016.2, June 2016 or “LLVM-CHIMPS: Compilation Environment for FPGAs Using LLVM Compiler Infrastructure and CHIMPS Computational Model”, Seung J. Lee, David K. Raila, and Volodymyr V. Kindratenko, Reconfigurable Systems Summer Institute 2008 (RSSI '08), Champaign, IL, July 2008.

A set of back-end instances translate the collection of IR programs 145 to a collection of executable programs 160, with at least one executable counterpart to every program in collection 145. Each instance of the back-end may be a different type of back-end tool from a collection of back-end tools such as the examples described above. In one embodiment, one back-end instance running on a computer 102 as shown in FIG. 1 is used to generate the collection of programs 160 which may then be transferred to a computer connected to a network 300 for execution. The entry programs from collection 160 upon execution form a peer-to-peer network 350 and other executables in collection 160 are distributed to different computers in network 350 using the communication links in the network for further execution.

In another embodiment, front-end 130 and parallelization unit 140, running on a set of computers similar to computer 102, generate collection 145 and instances of back-end 150 are running on each computer in network 350. The back-end instances running on computers in network 350 then receive a set of IR programs from collection 145 using communication links in network 350 and translate the received programs to an executable form for collection 160 before execution.

Section 2 below describes in detail an embodiment of the apparatus that may be used to execute the collection of programs 160 output by compiler 103, forming and executing on a dynamic network 350.

### 2. Network Coordination and Execution Apparatus

FIGS. 1 and 2 shows a simplified schematic of an illustrative network 300 and 350 that may be used to execute the collection of programs 160 generated by compiler 103 described in section 1.

### An Illustrative Computer Network

The word computer is used in this work to mean any computing device capable of receiving a computer program in the form of a set of instructions and executing the instructions. For example, this may include devices like graphical processing units (GPUs), tensor processing units (TPUs), personal computers, laptops, mobile phones, or tablets or microcontrollers, or microprocessors or field programmable gate arrays (FPGAs), or even an interconnected network of such computing devices such as multicore processors or clusters of computers such as supercomputers or a personal computer with a connected GPU and other such examples.

The computer may include other supporting hardware such as a set of instances of memory storage devices, or interfaces to input or output information or signals, such as displays, keyboards, mouse, electrical motor controllers, network interfaces etc.

Furthermore, a computer may have an operating system or a supervisory software or hardware system that provides for virtual parallel computing devices such as threads or processes or sessions that may exceed the actual number of physical computing devices in the computer. The threads or processes or sessions may in such cases execute on the limited number of physical computing devices on a time-sharing basis.

A computer may thus have plurality of computing devices either physical or virtual available for computing and program execution. Each such computing device will be called a compute node. Thus, a computer for the purposes of this work may be any device with a set of compute nodes.

An illustrative network 300 is shown in FIG. 1. A computer in network 300 may further be paired with a networking interface or relay or switch 107 that:
i. allows different compute nodes on the computer to communicate with each other, assigns a unique local address to each compute node that connects to the interface for communication and stores the address to its memory
ii. allows assignment of a network address to the interface that other networking interfaces paired with other computers can use to communicate with the interface
iii. allows communication between the compute nodes on the computer to other network interfaces paired with other computers and compute nodes on such other computers; given the destination network addresses and local addresses assigned to such nodes

A network interface or relay 108 may also be an in-between node for two other network interfaces, allowing the relaying or forwarding of messages or information from one network interface to another.

A network interface may allow such communication through a shared memory access between the compute nodes or by the transmission of messages using a set of transmission mediums such as those using wires or transmission cables or wireless signal transmission such as radio waves, electromagnetic waves, or optical or acoustic wave transmission or other such methods that allow the transmission of information from one computer to another.

The transmission of messages between two network interfaces or compute nodes may be a direct communication between the two using a transmission medium or may include several other network interfaces relaying the messages from the message source to its destination using a set of such transmission mediums.

A network interface may also be paired with a network address translation (NAT) unit that allows the interface to identify compute nodes or other network interfaces connected to it by assigning a local address or identifying label that is different from the address or identifying label the connected node or interface identifies itself by, and stores information to translate between the local address or label and the node/interfaces address or label. The NAT thus allows the network to be divided into various sub-networks in which different address or labelling conventions may be used and the NAT allows the proper identification of source and destination nodes by translating the addresses between the different conventions and relays information appropriately.

A computer network may thus comprise of a set of computers with a set of network interfaces allowing the transmission of messages or information from one compute node to another in the network. The transmission of messages or information may involve a set of encoding and decoding steps and transmission protocols, for example the protocols used on the internet such as http, https, RTP, WebSocket, or other such protocols. The network may also comprise of various configuration of networks such as local area networks (LAN), wide area networks (WAN), near field communication (NFC), or any other such classifications for network types. The addressing scheme in the network may include various types of information such as IP addresses, port information or any other form of addressing scheme that assigns nodes with an identifiable label as a source or destination address in the network for communication.

More details and examples of computers, computer networks, networking interfaces and protocols can be found in reference books like Frydenberg, M., Sebok, S. L., Campbell, J. T., Vermaat, M. E., Freund, S. M. (2017), “Discovering Computers, 2018: Digital Technology, Data, and Devices”, United States: Cengage Learning; or Kurose, James F, and Keith W. Ross, “Computer Networking: A Top-Down Approach”, Pearson, 2017; the contents of which are included here by reference.

### Network Apparatus for the Invention

A network 300 supporting the execution of programs generated from the compiler of section 1, comprises of a set of computers, exemplified by computers C1-C9 and S1-S2. A set of instances of a peer-discovery-node 202 (shown in FIG. 2 running on computer S1), and a set of instances of a resource-interface-node 203 (shown in FIG. 2 running on C3-C7) are made to run on the computers in network 300. The network 300 may be a world-wide web network like the internet that comprises of a set of local area networks (LANs) and a set of wide area networks (WANs) or a local area network with a set of computers or just one computer with a set of compute nodes available for parallel computations.

A peer-discovery-node 202 may be an electronics system or a compute node or more generally a computer (as defined above), paired with a network interface that has a globally known network address or network domain name or unique identifying label. The globally known address or label for node 202 can be used by a set of computers in network 300 to send messages to node 202, receive response messages from node 202 in return and exchange connectivity or communication protocol information amongst nodes in network 300 to form new peer-to-peer connections. An instance of peer-discovery-node 202 may be running on a set of computers in network 300 exemplified by computers C1-C7 or S1-S2. Other additional characteristics of node 202 to support the required objects of the invention are detailed in section 2.1.

A resource-interface-node 203 may be an electronic hardware or software or a hybrid implementation of the two. Node 203 runs on or interfaces with a computer connected to a network 300 and provides the interfaced computers with functions or methods to connect with other computers or computing nodes from network 300. The methods allow computing nodes from network 300 to form a new peer-to-peer network 350, or to join or leave as a node from an existing peer-to-peer network 350.

The detailed descriptions for the nodes 202 and 203 are provided in sections 2.1 and 2.2 below.

### 2.1 Peer-Discovery-Node

The peer-discovery-node 202 is a collection of computer-implement methods, implemented as a set of instructions or computer program (software) running on a set of compute nodes or as electronic hardware such as memory devices and electronic logic circuits or as a hybrid implementation containing hardware and software. A peer-discovery-node 202 may be implemented using a set of computers or compute nodes connected to a network 300. The nodes in a network 300 running the methods for node 202 are assigned known network and local addresses such that a set of other computers in network 300 can communicate with node 202, and send and receive messages from node 202.

The node 202 may further act as an in-between relay for information to be passed from one computer in network 300 to another. The exchanged connectivity information between computers of network 300 may then be used by the computers to form separate peer-to-peer connections forming a separate peer-to-peer network 350. Node 202 thus serves to facilitate the propagation, exchange and discovery of information in network 300 and the formation of a new peer-to-peer network 350 with nodes or computers taken from network 300.

FIG. 15 shows a simplified schematic for an embodiment of a peer-discovery-node 202 and its methods. An incoming message 701 received by node 202 from a computer in network 300 or 350, is first processed by a method 202a used to validate credentials sent as part of the received message. The message is labelled as a valid message if the credentials in the message are considered valid or otherwise labelled as an invalid message.

The message is next processed by a message-type-decoding unit 702. The message-type decoder 702 determines the type of message received and redirects the message and any data contained therein as input to a set of the methods of node 202. The methods to be called are determined by certain identifiers or message labels received as part of the message. If no label or an unknown label or an invalid message is received a method 202g is used to process the message as an erroneous message. Method 202g may silently ignore the received erroneous message by performing no further processing for the incoming message 701 or may respond to the sender of the message with an error message.

Peer-discovery-node 202 may thus resemble a server application for an internet-based service or a web-service. The methods for node 202 then resemble call-back functions or service coroutines in a server application that get called to process incoming messages or requests and may be implemented as such.

Peer-discovery-node 202 may be connected to a memory storage device or to a database system 201 such as those used in internet server applications, to store and retrieve data as required by the methods for node 202. The database system may be shared between more than one instances of node 202 or may be private to each instance of the node 202. Another embodiment of node 202 may also be made with more than one database systems connected to node 202, where a set of databases may be private to the node instance and other connected databases may be shared with other instances of node 202.

The method 202a is used by node 202 to validate credentials sent as part of the received message. In another embodiment, method 202a may be skipped and the incoming message may be directly processed by message-type-decoding unit 702.

In embodiments that use method 202a, the message may also be checked for validity according to the rules of some specified protocols such as the order or data structure in which certain information is expected or the requirement of certain types of information to be present in the message for it to be considered a valid message. For an invalid message or invalid credentials, node 202 may send a response as an error message to the sending node using a method 202g. For a valid message a set of further processing steps 202b-f may be executed by node 202.

The collection of methods for node 202 further contains a method 202b to create a new persistent bidirectional or fully duplex connection between a node in network 300 and node 202. Method 202b is invoked by a label or identifier contained in the received message to request the opening of a new connection by the sender of the message. Method 202b may refuse connections for invalid requests or if certain other conditions such as capacity of connections are reached. For granting the request, the method stores information about the requesting node in a database and open a new persistent, bidirectional communication link with the requesting node. Such a connection may be used by the connected node or by node 202 to send messages to each other as long as the connection link persists.

A persistent, bidirectional link may be established using various communication protocols, for example using a WebSocket protocol (standardized by the Internet Engineering Task Force (IETF) under RFC 6455) or WebRTC (a world wide web consortium (W3C) recommendation) or any such communication protocol that allows for a fully-duplex communication between the connected nodes. Any further messages after such a communication link is established may arrive either using the original connection means with which a connection opening request was made or using the newly formed communication link. The peer-discovery-node 202 may use the newly formed bidirectional link to send messages to the connected node or relay messages from other nodes in network 300 to such connected nodes to propagate information in the network.

The collection of methods further contains a method 202c to process messages containing requests for advertising or propagating or broadcasting a message on behalf of a requesting node to other nodes in network 300 that are connected to node 202 instance processing the message using method 202c. A requesting node in network 300 may not have any information about other nodes or computers in network 300 to allow a direct communication to such nodes. Method 202c thus facilitates the propagation of information from the requesting node to other computers in network 300.

The information to be propagated using method 202c is attached as part of the message making a request to method 202c and may contain information such as identifiers for the requesting node, or estimates for computational, communication, hardware or software requirements generated by compiler 103 as described in specifications 105 in section 1, or source code for the computational or processing tasks to be performed, or other such information as required by the embodiment of compiler 103 and resource-interface-node 203 described below. The information to be propagated may be stored in a database 201 connected to node 202 and retrieved upon request by other methods or retrieved and transmitted later by a method 202f to a requesting node from network 300.

The collection of methods for node 202 may further contain a method 202d to process messages containing a request to transmit or exchange connection information or messages from a requesting node in network 300 to a set of specified destination nodes connected to node 202. The connection information to transmit may contain different data objects such as session description protocol (SDP) information or interactive connection establishment (ICE) candidates that are used by the WebRTC protocol to establish peer-to-peer connections between two nodes. Such connection information may describe protocols and routing information needed for two nodes in network 300 to communicate with each other with a peer-to-peer connection.

A node in network 300 may not have the required information about another node in the network 300 to establish a peer-to-peer communication link, and method 202d enables the nodes connected to node 202 to exchange such information over the network 300 to then establish new peer-to-peer connections between the nodes, allowing the nodes to form a new, or join, a peer-to-peer network 350. The method may also serve as a server to relay information between nodes that cannot form direct communication links to one another.

In an alternate embodiment, the collection of methods in node 202 may further contain a method 202e to respond to messages requesting statistics or information about nodes connected to node 202 such as the number of nodes connected, the details of resources such as device types, device memory sizes available in the connected nodes. Such statistics may be aggregated and stored in the database by method 202b when new nodes open a connection with node 202. The stored information from the database is then retrieved by method 202e and transmitted to the requesting node. The required details for aggregating the statistics may be passed to method 202b as part of the message requesting to open a new connection or may be obtained by method 202b using the established bidirectional connection through a request-response process to obtain the required information.

The collection of methods in node 202 may additionally contain a method 202f to respond to a message from a node in network 300 requesting information about the set of computational or processing tasks advertised using method 202c. The information is retrieved from database 201 that was used to store such information by method 202c and transmitted as a response to the requesting node. The request-response pattern corresponds to a normal server-client model of interaction and thus may be used when a node is not connected to node 202 using a bidirectional communication link like the one formed using method 202b.

### 2.2. Resource-Interface-Node

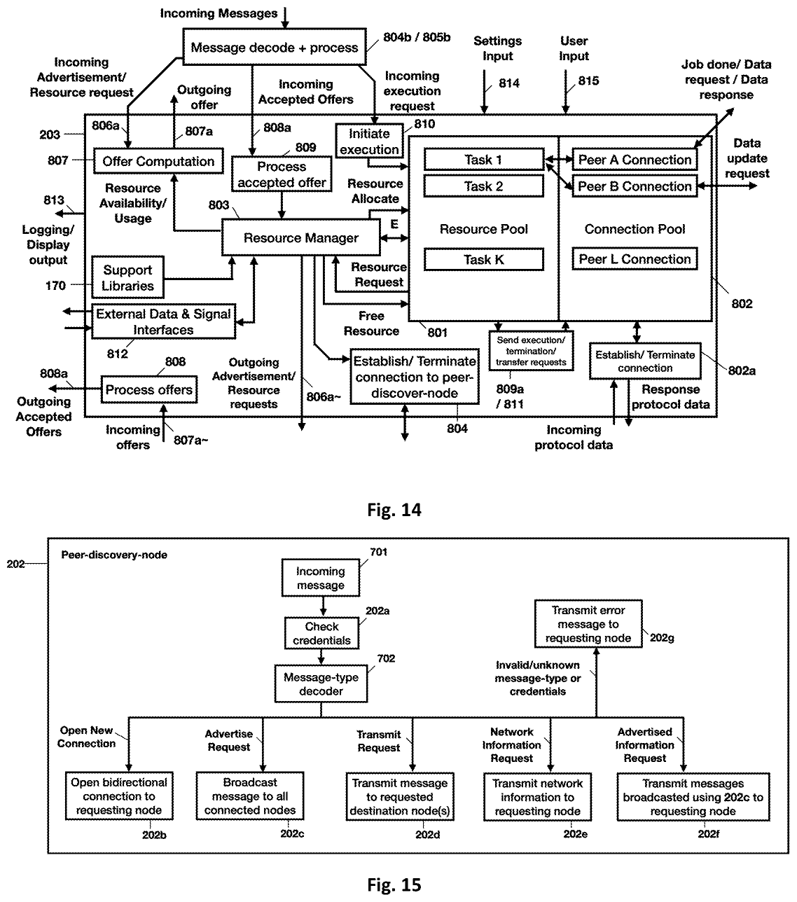

FIG. 14 shows an overall structure for resource-interface-node 203. A resource-interface-node 203 enables the execution of different programs on the computational nodes connected to it. The node 203 at the least comprises of:
a) a resource pool 801, with a set of compute nodes available for code or program execution;
b) a connection pool 802, containing a set of bidirectional communication links to a set of nodes from networks 300 or 350, or to nodes within resource pool 801. Connection pool 802 further contains, a method 802a to establish or terminate a bidirectional communication link with a node on the network, a method 802b to process incoming messages and a method 802c to send message to a node connected through the connection pool;
c) a resource manager 803 storing details of allocation of resources and communication links allocated to an executing program. Resource manager 803 further provides, a method 803a to allocate resources and add them to the memory table, and a method 803b to deallocate or free up resources and remove them from the memory table

In addition to the above, node 203 comprises of one or both of the following:
d) a method 804 to establish a bidirectional communication link to a peer-discovery-node 202, with, a method 804a for processing incoming messages from the peer-discovery-node and a method 804b to send messages to the peer-discovery-node, and/or
e) a method 805 to send a message to a set of instances of peer-discovery-node 202 containing a message of the type processed by methods 202b-f and a method 805b to receive and process a response message corresponding to the message sent using method 805.

The bidirectional link in method 804 may for example be a WebRTC protocol link or a WebSocket link with corresponding methods 804a and 804b for sending and receiving data specified by the protocols. Method 804b receives an incoming message, decodes the type of message and processes the message according to its type as described by methods 806-809 below. Method 805 may be for example may be a http or https protocol request sent to a server or a peer-discovery-node on an internet like network. Method 805b may be a client program that receives a response message and processes the message according to its type as described by methods 806-809 below.

### Node 203 Further Comprises of:

g) a method 806 to send a message 806a to a set of instances of node 202 or node 203. Message 806a containing advertisements or execution requests for programs from a collection of computer programs, such as collections 145 or 160 from the compiler in section 1 or collection 170 of support programs or libraries.

Message 806a contains information about the advertised tasks or programs such as an identifying label for the advertisement and identifying labels for the programs or tasks advertised for execution. Message 806a may additionally contain data such as estimates for the size of the computational, memory and communication workloads such as those available from the program specifications 105 output by the compiler in section 1. Message 806a may also contain additional conditions such as the time duration in which the advertisement remains valid, or the requirement of allocation or transfer of certain amount of credits under a credit system consisting of virtual tokens or money like objects implemented using the communication links in networks 300 or 350.

### Node 203 Further Comprises of:

f) a method 807 to process a received message of type 806a containing information about advertised computational or processing tasks, sent to node 203 using a bidirectional communication link from a node 202 or another instance of node 203 in a network 350, or as a response from node 202 to a request send using method 805 or using an input 815 to node 203.

Method 807 processes a received message of type 806a by computing a response to the advertisement. The computed response may be to ignore the advertisement and take no action, or it may be to send a response message 807a to the advertiser containing an offer to perform the advertised computational or processing tasks. Method 807 may further forward the received advertisement 806a or parts of advertisement 806a to nodes connected to the node instance 203 running the method.

The response message 807a to an advertisement 806a contains an offer to perform the advertised tasks. The node instance that sent advertisement 806a can accept the response offer 807a by sending an acceptance message 808a for the offer along with the required data and program code for the advertised tasks. The message 807a may include additional conditions to the offer under which the tasks will be performed such as the time duration in which the offer remains valid, or the allocation or transfer of certain amount of credits under a credit system consisting of virtual tokens or money like objects, which the advertiser must meet for node 203 to perform the advertised tasks.

Method 807 may receive information about the state of resource pool 801 such as the amount or capacity and type of resources that are free to be used or allocated. Method 807 may then use the state information to compute an offer message 807a to the advertisement 806a. In one embodiment of method 807, the method checks the resource pool state information and the advertised information 806a to check if the required capacity and type of resources specified for the computational tasks in 806a are available in the resource pool. If the requisite resources are not available, method 807 takes no further action and if available, it sends a response message 807a to the sender containing an offer to perform the advertised computational or processing tasks.

Method 807 may also be configured to forward the advertisement 806a to nodes connected to the instance of node 203 running the method through network 300 or 350. Such configuration may be performed through a setting input 814 to node 203 or may be requested as part of advertisement 806a. Method 807 may also be configured to send an offer 807a to perform only certain parts of the tasks requested in advertisement 806a and send out a new advertisement 806a˜ for the other parts of advertisement 806a. Such configuration may also be performed as part of the settings input 814 or as part of the original advertisement message 806a. The method may with such configuration receive offers 807a˜ in response to the modified advertisement 806a˜ and augment its offer 807a with information from a set of accepted offers 807a˜, with parts of the tasks to be run on node 203 running the method and other parts of the tasks to be run on the nodes with accepted offers 807a˜.

### The Node 203 Further Comprises of:

g) a method 808 to respond to offer messages 807a received in response to an advertisement 806a sent out to the network using method 806.

The advertising node may receive and process with method 808 a plurality of offer messages of type 807a coming from different instances of node 203. The method 808 may accept a set of offers 807a to perform the tasks by accepting the conditions contained in the chosen offers and sending the requisite data and program codes required to perform the tasks and to fulfil the accepted conditions as part of an acceptance message 808a to the chosen instances of node 203.

The method 808 receives a set of offer messages 807a in response to an advertisement message 806a and performs a sorting operation to rank the offers by a predefined preference or ranking criterion. For example, in the simplest case the ranking criteria may be a first-arrival criterion, in which, the offer messages 807a that are received before others are accepted first until the requisite number or type of resources specified in the advertisement 806a can be acquired from the networks 300 or 350. In another embodiment, the offer messages 807a may contain estimates or conditions representing the cost for performing the advertised tasks on the offering node 203. The method 808 may then sort the received offers in an increasing order of cost and accept the lowest cost offers to fulfil the requirements of the number and type of resources required by message 806a.

The acceptance message 808a sent in response to accepted offers may contain connection information such as session description protocol (SDP) offer or other communication protocol information required to initiate a peer-to-peer connection with the accepted offer node 203 instances. The message 808a may further contain program codes required to execute for the advertised tasks in 806a. The acceptance message may further contain other information or data required to fulfil the conditions in 807a such as a transfer of digital credits or other such tokens.

### The Node 203 Further Comprises of:

h) a method 809 to receive an acceptance message 808a and allocate resources in the resource pool 801 for the execution of tasks set in the corresponding offer 807a.
i) a method 809a to receive a request to transfer tasks set in an acceptance message 808a to a new node 203 using the transfer coroutines provided by the compiler for the task's programs in the collection 160
j) a method 809b to request information about a node running a specified section (S) from the programs in collection 160
k) a method 810 to receive an execution request from the advertising node for a program accepted through 808a and initiating execution for the requested program
l) a method 811 to send an execution or termination request for a program accepted through 808a

The method 809 may respond to an acceptance method 808a containing communication protocol information such as an SDP offer by responding with an SDP answer message or other such communication protocol steps to establish a peer-to-peer communication link with the node 203 sending the acceptance message 808a. The established peer-to-peer connection is managed by the connection pool 801 and methods 801a-c. The method 809 also receives the data and program codes for the tasks required to be executed. Method 809 then allocates the resources promised in message 807a for execution of the codes and stores the code into memory accessible by the allocated resources. The method 810 can then receive an execution request such as the one sent by an instruction in a peer or entry program inserted by the compiler in code blocks 613i or 614i. Method 810 after receiving a request for execution and initiates execution of the requested programs.

Method 809 may further validate the received programs using previously obtained information in the advertisement 806a to ensure that the sent programs are valid and in accordance with the programs that were advertised through the advertisement 806a. Such a validation of data or program codes can be performed for example by computing a hashed valued for the data or code sent to method 809 and comparing the computed hashed value with a hashed value for the data or program code provided as part of the advertisement message 806a.

The method 809 may also include a processing step to transform any programs received in an intermediate representation (IR) form such as those provided by the compiler in the collection of programs 145. The processing step receives IR programs and transform them to an executable form using an instance of the compiler back-end 150. The node 203 may contain a copy of support library codes 170 to support the linking of appropriate codes through the back-end 150 to create the executables.

The method 809b checks with the peer-discovery-node 202 using a message to its method 202f to see if section (S) has been already advertised and allocated a node, if yes, the details for the allocated node are returned by 202f to 809b which returns the details to the instruction calling the method 809b. If section (S) is not already advertised, the method 809b sends out an advertisement message 806a configured using the specifications for section (S) from specifications 105, to a peer-discovery-node 202 and acquires the required allocation of nodes using the methods 807-809. The information for the allocated nodes is then returned to the calling instruction for method 809b. If already advertised but nodes are not allocated the method 809b waits till the allocation is completed to get the details 202f. It may achieve such a wait by polling 202f at regular intervals to check the allocation or by relying on the bidirectional communication link with node 202 to send to method 809b an update whenever the allocation is completed.

In one embodiment, the resource-interface-node 203 may perform several rounds of negotiations sending advertisements 806a and receiving offers 807a with adjusted costs or conditions to in each round to resolve differences in available offer and advertisement conditions to acquire the required resources for the execution of programs from collection 145 or 160.

FIG. 14 shows a few more optional components for node 203 embodiment. The extra components may include:
a) an interface 812 to external resources such as storage mediums, or network interfaces, or signal interfaces
b) a logging or display output 813
c) a settings or configuration input 814
d) a user input 815
e) a collection of stored or cached support library programs 170

The interface 812 may be made available upon request to programs executing in the resource pool 801. The interface 812 may provide access to other hardware resources connected to a computer running the node 203. The output 813 provides an interface to a logging or display output that methods in node 203 or programs running on the resource pool 801 may use to log to memory or display information to a user. A settings or configuration input 814 may be included in the node 203 to provide various configuration inputs or options settings for the node 203 and its methods. The settings 814 may include inputs to specify the credentials required for the node 203 to communicate with the peer-discovery-node 202 or to specify network addresses for a set of peer-discovery node instances or to specify configuration for the methods in node 203 such as method 807 described above.

A user input 815 may be included to provide a user input for the initial program collection 160, specifications 105 and an initial advertisement message containing the tasks set in the entry programs for the collection 160 to an instance of the node 203. The advertisement message for the entry programs is then processed by the method 807 as described above. The user input 815 may further be used to request termination or transfer of tasks running on the network 350 that were initiated on behalf of the node 203 instance.

The node 203 may be implemented as a computer software, or as an electronic hardware such as using logic circuits and memory units, or a hybrid implementation where some of the functionality described for the node is implemented in a set of computer software and a set of functionality is implemented as electronic hardware such as logic circuits, memory units and computers running the software parts.

### 3. Operation

The following describes the complete operation of the invention comprising of a compilation process using an embodiment of the compiler described in section 1 and the execution of the compiled program using an embodiment of the network apparatus described in section 2.

An input computer program 101 is compiled by compiler 103 as described in section 1 to output a collection of programs 160 and corresponding program specifications 105. A computer C1 (as shown in FIG. 1) may be used to run compiler 103. The collection of computer programs 160 and specifications 105 are transferred to a computer C3 connected to a network 300 to initiate execution of the compiled programs. In an embodiment the computers C1 and C3 may be the same computers.

The collection of programs 160 contains programs marked by compiler 103 as “entry programs” which are required to be executed to start the execution of the programs in collection 160. The computer C1 and network 300 are exemplified in FIG. 1. Computers instances C3-C9 in FIG. 1 are equipped with instances of the resource-interface-node 203, while computer instances S1-S2 are equipped with instances of the peer-discovery-node 202.

To initiate execution for a collection of programs 160, the collection 160 and corresponding specifications 105 are input to an instance of the resource-interface-node 203 running on computer C3 using the user input 815 to node 203. An advertisement message 806a containing specifications for the entry programs for the collection 160 is input to the node 203 using input 815. The program specifications 105 contain information about the programs in 160 such as data and control-flow interdependencies between the programs, estimates for the computational, memory and communication workloads expected from the programs, hashed representations for the programs and other such program descriptions. The specifications 105 can thus provide the necessary descriptions for the tasks to be performed for the entry programs.

The specifications 105 serve as the initial advertisement message of type 806a sent to the instance of node 203 running on C3 using the node input 815. The advertisement 806a is processed by the method 807 on the node 203 running on computer C3. A user or programmer may choose to augment the specifications 105 to form the initial advertisement message 806a. Such an augmentation may include additional conditions for execution such as limits on the costs incurred for acceptance of offers of type 807a received or to request the method 807 to forward the advertisement or parts of the advertisement 806a to the nodes connected to computer C3 through the network 300 for the acquisition on additional resources from the network.

The method 807 based on the configuration provided through the settings input 814 or as part of the initial advertisement message 806a creates an offer message 807a to execute all the tasks set in the advertisement message. The offer 807a may be generated by sending out additional advertisements 806a˜ to perform different parts of the advertisement 806a, as described in section 2.

The method 807 running for node 203 on computer C3 may be configured using the settings input 814 or the initial advertisement 806a to create an offer for some parts of the entry programs from collection 160 and send out an advertisement 806a˜ to perform other parts of the advertisement 806a. The advertisement 806a˜ is sent out to all the nodes connected to computer C3.

The nodes connected to computer C3 may be configured by the settings input 814 to contain a set of nodes running an instance of the peer-discovery-node 202, exemplified by nodes S1-S2 in FIG. 1. The resource-interface-node 203 is provided the network address of a set of peer-discovery-node 202 instances through its settings input 814 and tries to connect to the node 202 instances using method 804 when first initialized or when requested through a user input in the settings 814. When a bidirectional communication link established using method 804 is available, the node 203 instance running on computer C3 sends out the advertisement message 806a˜ to the connected peer-discovery-node 202 using the specified method 804b for the communication link. If the bidirectional communication link is not available, the node 203 may use the network request method 805 to send out the advertisement 806a˜.

The peer-discovery-node 202 upon receiving an advertisement request 806a˜ invokes its method 202c to broadcast the advertisement 806a˜ to all resource-interface-nodes 203 connected to it using the method 804. The other instances of node 203 on the network 300, exemplified by instances running on computers C4-C9 in FIG. 1, receive this forwarded advertisement 806a˜. The method 807 instances running on computers C4-C9 send their response offer messages of type 807a˜ to the broadcasting node 202 with a transmit request to forward the offer messages to the original advertising node running on computer C3. Method 202d on the peer-discovery-node transmits the response offers to computer C3 using the bidirectional link method 804 or as a response to the message sent using method 805 as the case may be for the communication method used to send the original message 806a˜ or the form of communication link available to computer C3 at the time of the arrival of an offer message 807a˜.

The resource-interface-node 203 running on computer C3 may thus receive multiple offer messages 807a˜ in response to the advertisement 806a˜. The node 203 may be configured to by the settings input 814 or the original advertisement 806a to wait for a fixed time in which to receive all possible offers 807a˜ before making a decision on which offers to accept. This time window is the time window in which the advertisement 806a˜ may be considered valid and only offers received before the expiration of such time will be considered for acceptance by the node 203. After receiving all the offers 807a˜ in the fixed time window, node 203 processes the offers according to method 808 to accept a set of offers 807a˜ for performing the tasks sets in message 806a˜.

The method 808 transmits an acceptance message 808a containing communication protocol information such session descriptions protocols (SDP) or interactive connectivity establishment (ICE) candidates or other such protocol information required to establish peer-to-peer communication links with nodes for which offer 807a˜ were accepted by method 808. The method 808 uses the peer-discover-node method 202d to transmit such information to the accepted nodes.

The method 808 further sends the required data and program codes from collections 160 and 170 that are required for execution of the tasks set in message 806a˜. The method 808 may use the peer-discover-node 202 to transmit the data and program codes required or in another embodiment may use the peer-to-peer link established by method 808 to send such information.

FIG. 2 shows an example of a peer-to-peer network 350 being formed as a result of the method 808 described above. The example in FIG. 2 assumes that offers 807a˜ sent by resource-interface-nodes on computers C5-C7 were accepted by the method 808 running on computer C3, resulting in the formation of a new peer-to-peer network 350 as shown in FIG. 2. A peer-discovery-node running on computer S1 is shown in FIG. 2 facilitating the formation of a peer-to-peer link 112 between computers C5 and C7 using links 110 and 111 respectively for the computers C5, C7 nodes to the peer-discovery-node on computer S1. The method 808 also stores the correspondences between the accepted nodes and the tasks they will perform in the memory of the resource manager 803.

The method 809 on accepted nodes 203 receive the acceptance message 808a allocate the resources promised in their corresponding offers 807a˜ and save any received data and program codes in memory accessible by the allocated resources. The method 809 initiates the execution of the received entry programs on the allocated resources immediately after receiving the data and programs.

Further nodes from the network 300 are acquired for other programs such as peer programs or the other coroutines from the collection 160 when the entry programs execute instructions to request nodes for further peer programs using method 806. The nodes are acquired using the same process following the exchange of messages performed using methods 806-809. The method 808 accepts or acquires a set of nodes from the network 300 for the execution of the requested programs and establishes peer-to-peer communication links with the acquired nodes, forming the peer-to-peer network of nodes 350.

The peer programs are executed by the acquired nodes when the requesting programs (entry programs in this case) execute the instructions inserted by the compiler 103 for sending a message or signal for execution of the above peer or coroutine programs using the method 811 from node 203. The node 203 stores in its resource manager 803 the communication links or labels to be used to send messages to nodes allocated to each advertised program. Method 811 sends the message requesting the program execution to the corresponding destination node stored in the resource manager 803 when invoked by an instruction in an executing program from collection 160.

The destination node upon receiving a request to execute a program invokes method 810 and initiates the execution of the peer or coroutine programs that are specified in the request. The program instructions inserted by compiler 103 and methods 810 and 811 thus work together to start the execution of the peer programs and coroutines from collection 160 across the distributed nodes in the established peer-to-peer network 350.

The peer programs and their coroutines further invoke methods 806-809 to acquire more nodes from network 300 when executing instructions inserted by the compiler 103 to these programs, in particular to the runtime-management-coroutine 614 instances, for acquiring resources for further peer programs from collection 160. The newly acquired nodes by the peer programs are then added to the established peer-to-peer network 350. The execution of programs on the new nodes is initiated following the invocation of methods 811 and 810 on the requesting node and acquired nodes respectively.

The above process of adding new nodes to network 350 and initiating execution of peer programs on the acquired nodes continues until all programs from collection 160 have been allocated a node and initiated for execution.

The nodes creating offers 807a˜ in response to an advertisement 806a˜ may themselves also create the offers by performing part of the tasks set in 806a˜ and create a new advertisement for the remaining parts. The nodes then repeat the same process as the one performed by computer C3 above and receive further offers from computers in network 300 to perform all the tasks set in 806a˜. The offers sent by such a node is formed by combining the node's offer for tasks performed by the node and further offers accepted by the node to perform the remaining tasks from 806a˜.

The instructions inserted by compiler 103 in the programs from collection 160 to request nodes from a network invoke methods 807-811 to acquire nodes for executing the programs requested through the inserted instructions.

The tasks outlined in the collection 160 thus get distributed through the network and the execution and communication required for the execution of programs in collection 160 is supported by the dynamic formation a new peer-to-peer network 350. Any errors or display output required to the user may be transmitted through the network and displayed to a user using the display or logging output 813.

As an additional operational feature, node 203 may receive a request to transfer the execution of a set of tasks allocated by it to another node in the network 350. Such a request may be initiated by a user of node 203 using the node's user input 815 or may be invoked if the node executing the tasks reports a fault in its execution or loses communication permanently. A request to transfer execution of a program from collection 160 is processed by executing a node transfer coroutine 613 generated for the program by compiler 103. The node transfer coroutine invokes the methods 807-809 in the network to acquire new nodes for the tasks and contains instructions to send the corresponding programs and data to the new nodes, initiate execution on the new nodes and stop execution on old nodes to complete such a transfer of execution.

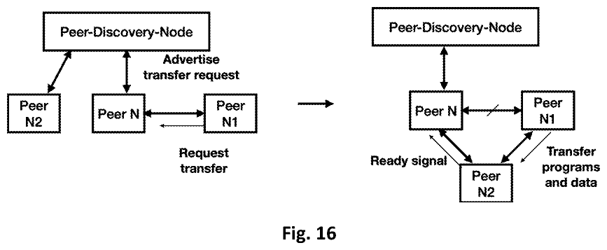

FIG. 16 shows a job transfer request being processed by the node 203 labelled “Peer N” to acquire a new node “Peer N2” to transfer the execution of programs running on “Peer N1”. The transfer coroutine acquires the new node “Peer N2” through the advertisement-offer acceptance process outlined in methods 807-809, a new peer-to-peer link between “Peer N” and “Peer N2”. The transfer coroutine further transfers the operational data and program codes from “Peer N1” to the new node “Peer N2”. Finally, the coroutine terminates the execution of the programs running on the old node and initiates execution of the programs on the new nodes. In case of a loss of communication or fault in the old node “Peer N1”, the advertiser of the tasks (“Peer N” in this case) transfers the programs and data to the new node “Peer N2” to reinitiate the execution of the programs requiring the transfer.

In another embodiment for the compiler 103, the input program 101 is processed using the compiler's front-end 130 and parallelization unit 140 to output the collection of IR programs 145. The methods 806-809 from node 203 then lead to distribution IR programs from collection 145 in the network 350. A back-end 150 instance and support library 170 instance are included in the embodiment for node 203. Method 809 for such an embodiment take the received IR programs and transforms them to executables of the form expected in collection 160 using the back-end 150 included in node 203. Back-end 150 may link IR programs to a set of external programs present in support library 170 as specified using the software requirement specified in the advertisement message 806a sent to node 203 for the corresponding IR program.

The embodiment for compiler 103 and node 203 where back-end 150 processing is performed as part of method 809 in node 203 supports the third object for the invention. With such an embodiment, input program 101 and IR programs 145 may specify the use of software or hardware requirements or functions or methods or procedures that are not available with the computer C1 on which the programming or compilation front-end 130 and parallelization unit 140 processing is performed. The required hardware or software functionalities may however be available with a set of nodes in networks 300 or 350. The advertisement message 806a then includes the required functionalities as a part of its specifications for the programs to be executed and nodes providing or specializing in the functionality can be acquired from network 300 using the methods 806-809. The back-end 150 on the acquired nodes then links the received IR programs to any specialized software requirements from its collection of programs in support library 170, or provides access to any hardware requirements through interface 812.

The above description provides examples of sequence of operations in which the compiler and network apparatus of the invention may be used to distribute and run the programs generated in collections 145 or 160 using a dynamic and self-organizing network 350. Network 350 is dynamic in the sense that new nodes and topological changes are possible to the network during the execution of the programs in collection 160. The network is self-organizing in the sense that the executing programs themselves request and acquire nodes as required for the execution of the different tasks or programs. Such a dynamic, self-organizing network 350 allows the network to automatically scale and acquire resources in proportion to the workload encountered by the programs and the runtime input data. The self-organizing mechanisms provided by methods 806-809 also allow acquiring nodes for the network 350 within the specified limitations of the costs or resource availability in the larger network 300.

The above description is illustrative, and does not preclude other ways or sequences of operations that may be performed using the compiler and network apparatus described in sections 1 and 2. Further, in the claims, the word “comprising” does not exclude other elements or steps, and the indefinite article “a” or “an” does not exclude a plurality. The mere fact that different features are recited in mutually different dependent claims does not indicate that a combination of these features cannot be advantageously used. Further the use of names such as “peer-discovery-node” or “resource-interface-node” in the claims does not imply any name binding on the components described by the claims. The components described in the claims may be renamed without changing the underlying claims or descriptions. The methods described separately for resource-interface-nodes and peer-discovery-nodes does not exclude the methods, in full or in parts, from being combined advantageously into a single entity.

The meaning of a few general terms or names used in the description above are summarized below in section 4 for convenience.

### 4. Meanings of Names

4.1 Set: A collection of objects of a specified type, containing at least one member.

4.2 Subset: A subset of a set is a collection of one or more members of the set.

4.3 Compiler: Generally speaking, a compiler is a computer implemented method (e.g., a set of computer-executable instructions) that is configured to translate or transform an input computer program, which may be represented in a high-level programming language such as C, C++, or any other suitable programming language like assembly or an intermediate representation language, into object code.

4.4 Object code: Object code may be represented in the form of instructions and data suitable for processing by a target computing architecture, although in some embodiments, additional processing (e.g., linking) may be performed on generated object code to transform object code into machine-executable code.

4.5 Computer: The word computer is used in this work to mean any computing device capable of receiving a computer program in the form of a set of instructions and executing the received instructions. For example, this may include devices like graphical processing units (GPUs), tensor processing units (TPUs), personal computers, laptops, mobile phones, or tablets or microcontrollers, or microprocessors or field programmable gate arrays (FPGAs), or even a network of such computing devices, such as multicore processors or clusters of computers such as supercomputers or a personal computer with a connected GPU or other such combination of devices.

4.6 Client-Server networking model: Client-server model is a distributed application structure that partitions tasks or workloads between the providers of a resource or service, called servers, and service requesters, called clients. Often clients and servers communicate over a computer network on separate hardware, but both client and server may reside in the same system. A server host runs a set of server programs, which share their resources with clients. A client requests content or service from a server. Clients, therefore, initiate communication sessions with servers, which await incoming requests, process the request and may send a response message in return to the requesting client.

4.7 Peer-to-peer network: A peer-to-peer network is a set of computers connected to each other via bidirectional or fully duplex communication links in which computers are equally privileged in sending and receiving messages using the communication links (in contrast to the client-server model, in which the server cannot initiate a communication or connection to a client computer). The computers in a peer-to-peer network are often referred to as nodes or peers in the network.

4.8 Peer, or peer node, or computer node, or compute node, or computing node: A peer, or peer node, or computer node, or compute node, or computing node is any computer, or computer process, or thread in a computer, capable of receiving and executing a computer code or program. The type of a computing node may be further characterized by the type of hardware, memory or software resources available to the computing node.

4.9 Coroutines: Coroutines are computer program components that generalize functions for multitasking or parallel execution by allowing execution of the coroutine to be suspended and resumed. Coroutines can be paused or resumed by the computer system executing the program in response to external signals such as network responses, external hardware signals or user inputs.

4.10 Dependency fault: A dependency fault occurs when an instruction is executed while the data inputs required for executing the instruction are not available, or invalid.

4.11 Control fault: A control fault occurs in a compiled code, if an instruction is executed in an order of execution that changes the outcome of a computer program in a manner not intended by the original input computer program.

4.12 Code Section: A computer program.

4.13 Computer Process: A “computer process” is the performance of a described function in a computer system using computer hardware (such as a processor, field-programmable gate array or other electronic combinatorial logic, or similar device), which may be operating under control of software or firmware or a combination of any of these or operating outside control of any of the foregoing. All or part of the described function may be performed by active or passive electronic components, such as transistors or resistors. In using the term “computer process,” we do not necessarily require a schedulable entity, or operation of a computer program or a part thereof, although, in some embodiments, a computer process may be implemented by such a schedulable entity, or operation of a computer program or a part thereof. Furthermore, unless the context otherwise requires, a “process” may be implemented using more than one processor or more than one (single- or multi-processor) computer.

4.15 Network of resource interface nodes: A network of resource interface nodes is a set of resource interface nodes, and a set of communication links, each communication link connecting one resource interface node of the set to a second resource interface node of the set. The network may have different network topologies, a network topology being the arrangement of nodes and links of the network. The network topology may be dynamic in the sense that the topology may be changed over time by adding or removing nodes and links from the network. The network may include additional nodes such as peer discovery nodes for relaying messages as described above.

4.16 Extensible network: A dynamic network with a topology that may be changed by the addition or removal of nodes and links in the network, utilizing computer implemented methods for reconfiguring and changing the network topology. The computer implemented methods may be invoked by network reconfiguration requests or commands from existing nodes in the network or by an external node requesting access to the network.

1. A method of compiling an input computer code, partitioned into a set of code sections, in a manner to support execution of the code sections by a plurality of computing nodes in an extensible network, the method utilizing computer logic executing on a computer system to establish computer processes comprising:
a) receiving by the computer system, the partitioned set of code sections, the partitioned set having at least two code sections, with at least one code section having a control flow dependency on another code section;
b) processing the partitioned set of code sections in a manner, wherein for each given first code section having a control-flow dependency on at least one second code section, causing selection of a particular second code section and supplementing the selected second code section with (i) instructions for transmitting a network reconfiguration request to the extensible network for allocation of a new set of computing nodes for execution of the given first code section, (ii) instructions to receive network specifications for the new set of allocated computing nodes in response to the network reconfiguration request, (iii) instructions to transmit a subset of code sections of the partitioned set to the new set of allocated computing nodes over the network utilizing the received network specifications;
c) providing, as an output, the processed partitioned set of code sections including the supplemented instructions.

2. A method according to claim 1, wherein in processing the partitioned set of code sections, for each given first code section having control-flow dependency on the selected second code section, the method further includes supplementing the selected second code section with instructions to transmit an execution request to the new set of computing nodes for execution of the first code section.

3. A method according to claim 1, wherein the computer processes further comprise processing the partitioned set of code sections in a manner that for each given first code section of the partitioned set having a data-dependency on a third code section of the partitioned set, supplementing the first code section with instructions to transmit a request for data required by the data-dependency to the extensible network.

4. A method according to claim 1, wherein in processing the partitioned set of code sections, for each given first code section having control-flow dependency on the selected second code section, further supplementing the selected second code section with (i) instructions to receive, from the extensible network, a transfer request, for transfer of the first code section to a first computing node of the network, (ii) instructions to respond to the transfer request by transmitting the first code section to the first computing node, if the first code section is available to the computing node executing the second code section, and otherwise transmitting the transfer request to a second computing node of the extensible network with access to the first code section for transfer to the first computing node.

5. A method according to claim 1, wherein processing the partitioned set of code sections further includes identifying the data and control-flow dependencies between the code sections of the partitioned set and providing as an additional output the identified data and control-flow dependencies as a collection of code section specifications.

6. A method according to claim 5, further comprising identifying a subset of code sections, in the set of code sections, having no data or control-flow dependencies on other code sections, and wherein the additional output further includes labelling of code sections of the identified subset as entry programs, the execution of which is required to initiate execution of remaining code sections in the set.

7. A method according to claim 5, further comprising providing as the additional output, for each code section of the partitioned set of code sections, a code section specification including any of the estimates for computational, memory, or communication workloads, or software or hardware dependencies, or code integrity tokens, or credential tokens for the code section.

8. A method according to claim 3, wherein, in processing the partitioned set of code sections, for each given first code section of the partitioned set having a data-dependency on the third code section of the partitioned set, further comprising supplementing the third code section with instructions to respond to the data request received over the network by sending the requested data over the network to the requesting computing node executing the given first code section.

9. A method according to claim 3, wherein, in processing the partitioned set of code sections, for each given first code section of the partitioned set having a data-dependency on the third code section of the partitioned set, further comprising supplementing the given first code section with instructions to receive data sent to it by another computing node, post-process the data according to the post-processing needs identified by the data-flow analysis for the data-dependency.

10. A method according to claim 1, wherein supplementing the selected second code section includes inserting instructions to verify credential tokens attached to a message received from a node on the network and instructions to conditionally execute instructions to process requests or data contained in the message, only if the credentials are valid.

11. A method according to claim 1, wherein supplementing the selected second code section includes inserting instructions to select the type and number of computing nodes to request from the extensible network for execution of the given first code section, and instructions for transmitting the network reconfiguration request to the extensible network specify the selected type and number of computing nodes.

12. A method according to claim 1, wherein supplementing the selected code section includes insertion of instructions as a coroutine function, the method further comprising supplementing the coroutine function with instructions to pause and resume execution of the coroutine function in response to an external signal.

13. A method of compiling an input computer code in a manner to support execution of the compiled code by a plurality of computing nodes in an extensible network, the method using computer logic executing on a computer system to establish computer processes comprising:
a) partitioning the input computer code into a partitioned set of code sections according to the limitations of claim 1 for the partitioned set; and
b) compiling the partitioned set of code sections utilizing the method of claim 1.

14. A method according to claim 13, wherein partitioning the input computer code into a partitioned set of code sections further includes computing an objective function value that measures efficiency of the partitioning and modifying the partitioned set of code sections iteratively to optimize the objective function value.

15. A method according to claim 12, further comprising, for each given first code section of the set, generating a coroutine including instructions for (i) transmitting a request for a second computing node from the extensible network to take over execution of the first code section executing on a first computing node, (ii) transmitting the first code section to the second computing node, and (iii) transmitting data stored during the execution of the first code section on the first computing node to the second computing node.

16. A computer implemented method for creating a first self-organizing, extensible network of computing nodes from a second network of resource interface nodes, the method utilizing computer logic executing on a first resource interface node of the second network to establish computer processes comprising:
a) receiving by the first resource interface node, a set of code sections and a first request for execution of a first code section of the set on a first computing node connected to the first resource interface node;
b) responsive to receiving the first request, causing allocation of the first computing node by the first resource interface node and initiating execution of the first code section on the first computing node;
c) receiving by the first resource interface node a second request, from the first code section executing on the first computing node, for allocation of a second computing node for execution of a second code section of the set and transfer of a first subset of code sections of the set to the second computing node; and
d) responsive to the second request, processing the second request by selecting a second resource interface node of the second network, and transmitting the second code section and the first subset of code sections to the selected second resource interface node with a request for execution of the second code section, causing allocation of the second computing node for execution of the second code section by the selected second resource interface node.

17. A computer implemented method according to claim 16, wherein, in processing the second request, communicating with a set of resource interface nodes through offer-response messages to receive a corresponding set of offers for allocation of the second computing node and selecting, from the set of offers, a selected offer and selecting the second resource interface node corresponding to the selected offer, to transmit the second code section and the first subset of code sections for execution of the second code section.

18. A computer implemented method according to claim 16, wherein the first resource interface node responds to a first data request, by the first computing node, for data from the second computing node, by causing generation of a third request for a first new communication link between the computing nodes, the computer processes further comprising, responsive to the third request, communicating with the second resource interface node to receive network specifications for the second computing node and causing formation of the first new communication link between the first computing node and the second computing node.

19. A computer implemented method according to claim 16, wherein the first resource interface node provides a response to a node transfer request to transmit a second subset of code sections, from the first computing node to a third computing node, the node transfer request including network specifications for the third computing node, the method further comprising causing the response to utilize the network specifications for the third computing node to form a second new communication link between the first computing node and the third computing node, and transmitting the second subset of code sections to the third computing node.

20. A computer implemented method according to claim 16, the computer processes further comprising:
a) receiving by the first resource interface node, a fourth request from the first computing node for execution of an external code section not included in the set of code sections;
b) responsive to the fourth request, causing a propagation of messages through the second network of resource interface nodes to request and receive network specifications for a fourth resource interface node of the second network with access to the external code section;
c) responsive to receiving network specifications for the fourth resource interface node, forming a communication link between the first resource interface node and fourth resource interface node, and transmitting a request for execution of the external code section to the fourth resource interface node.

21. A method according to claim 13, further configured for creating a first self-organizing, extensible network of computing nodes from a second network of resource interface nodes, the method utilizing computer logic executing on a first resource interface node of the second network to establish computer processes further comprising:
a) receiving by the first resource interface node, an input computer code, and in response, compiling the input computer code into a partitioned set of code sections utilizing the computer processes of claim 13 and identifying, a first subset of code sections of the partitioned set as entry programs;
b) responsive to compiling the input computer code into the partitioned set of code sections, transmitting a request to the first resource interface node for the execution of each of the code sections included in the first subset, causing allocation of computing nodes and execution of code sections from the first subset, the first subset of code sections consequently causing execution of any remaining code sections of the partitioned set of code sections.
